(19) United States
(12) Patent Application Publication
(10) Pub. No.: US 2014/0065367 A1
(43) Pub. Date: Mar. 6, 2014

(54) STRUCTURE HAVING SPECIFIC SURFACE SHAPE AND METHOD FOR MANUFACTURING SAID STRUCTURE

(71) Applicants: Tsukasa Matsumoto, Yokohama-shi (JP); Yoshihiro Maeda, Yokohama-shi (JP); Kazuya Sato, Yokohama-shi (JP)

(72) Inventors: Tsukasa Matsumoto, Yokohama-shi (JP); Yoshihiro Maeda, Yokohama-shi (JP); Kazuya Sato, Yokohama-shi (JP)

(73) Assignee: DNP FINE CHEMICALS CO., LTD., Yokohama-shi, Kanagawa (JP)

(21) Appl. No.: 14/116,868

(22) PCT Filed: May 17, 2012
(86) PCT No.: PCT/JP2012/062694

§ 371 Date: Nov. 11, 2013

(30) Foreign Application Priority Data
May 17, 2011 (JP) 2011-110889

(51) Int. Cl. G02B 1/11; B29C 35/08

(52) U.S. Cl. CPC G02B 1/111; B29C 35/0866; B29C 35/0805
USPC 428/141; 264/485; 264/496; 252/582

(57) ABSTRACT

There is provided a structure having convex parts with an average height of 100 nm or more and 1000 nm or less, or concave parts with an average depth of 100 nm or more and 1000 nm or less on a surface thereof. The convex parts or the concave parts thereof are present at an average cycle of 50 nm or more and 400 nm or less in at least one direction. The structure is obtained by polymerizing a polymerizable composition containing a (meth)acrylate compound by light irradiation, electron beam irradiation and/or heating, the (meth)acrylate compound contains 53% by mass or more polyethylene glycol di(meth)acrylate based on the whole (meth)acrylate compound. The structure has a storage elastic modulus at 25° C. of 2 GPa or less and/or a storage elastic modulus at 180° C. of less than 0.5 GPa.

### TECHNICAL FIELD

The present invention relates to a structure having a specific surface shape, more specifically to a structure comprising a polymer of a polymerizable composition containing a specific compound and having a specific surface shape. It also relates to a structure to be used for, in particular, antireflection of light and/or improvement in light permeability.

### BACKGROUND ART

For a surface layer used for a display and the like, (a) those obtained by a method generally referred to as a dry method, i.e., making a dielectric multilayer film in a vapor phase process and realizing a low reflectance with an optical interference effect, (b) those obtained by a method generally referred to as a wet method, i.e., coating a low refractive index material on a substrate film have been used. As a technology which is quite different principally therefrom, (c) it has been known that the low reflectance can be realized by providing a fine structure to the surface (Patent Document 1 to Patent Document 14).

In general, such a surface layer has required not only an antireflection performance of light and an improved performance of the light permeability, but also a certain mechanical strength to withstand abrasion and scratches in practical use, and a stain is difficulty attached and removal of a stain is easy.

However, for the surface layer having the fine surface structure described in the above (c), whereas the good antireflection performance is obtained, the mechanical strength such as surface scratch resistance, etc., and antifouling property, etc., are insufficient. Thus, there are problems that the surface layer is easily abraded and is easily scratched, and a stain is easily attached or difficulty removed. Therefore, it has not yet come in practical use.

For example, in Patent Document 1 to Patent Document 13, materials for such an antireflection film are listed, and a (meth)acrylate compound is described therein to be used as a polymerizable compound. However, the materials listed there are quite usual materials for forming an ordinary structure, and they are not the materials which are discussed from the aspect that the surface layer having the specific fine surface structure described in the above-mentioned (c), which is made practical for the mechanical strength such as surface scratch resistance, etc., antifouling property, contamination resistance, etc., by selecting these materials.

Patent Document 14 is to focus on the mechanical strength such as surface scratch resistance, etc., in the surface layer having a specific fine surface structure of the above-mentioned (c), and to solve the problem from the aspect of the materials. However, for the purpose of further improving mechanical strength of the surface, difficulty in adhering a stain to the surface, etc., there was room for further improvement from both of physical properties of the surface and materials to be used.

Also, in Patent Document 15, there is a disclosure about an antireflection film having a specific fine surface structure of the above-mentioned (c), but Patent Document 15 concerns a technology to improve haze of the antireflection film, and not to improve mechanical strength such as surface scratch resistance, etc., or contamination resistance. Further, it relates to an invention having a characteristic feature in the mold to obtain a fine surface structure by transcription, and not an invention having a characteristic feature in the material of an antireflection film constituting a structure. In fact, the polymerizable compositions described in Examples of Patent Document 15 contain polyethylene glycol di(meth)acrylate in an amount of less than 50% by mass alone based on the whole (meth)acrylate compound.

In addition, in Patent Document 16, a hydrophilic antireflection film having a contact angle of less than 90° has been disclosed, but an object and an effect to make the contact angle less than 90° are to prevent from clouding (defogging), and are not to improve mechanical strength such as surface scratch resistance, etc., or contamination resistance, and thus, it is quite different as a material. In fact, in Example of Patent Document 16, there are usual materials such as SiO₂ (sol-gel film), PMMA (poly(methyl methacrylate)), polystyrene, etc.

“An antireflection film having a fine structure on the surface” of the above-mentioned (c) has an extremely specific fine structure on the surface to prevent the reflection suitably, so that for improving the physical property on the surface as mentioned above, specificity is required to the material to be used, and an extremely specific physical property is required to the surface of the obtained structure. However, what kind of physical property is required has been scarcely investigated.

In recent years, it has been required to have antireflection property of light or excellent light transmittance, etc., increasingly not only for the uses of a flat panel display (FPD) such as a liquid crystal display (LCD), a plasma display (PDP), an organic light-emitting diodes (OLED) utilizing an organic EL (OEL), and a field emission display (FED), etc., but also for a cathode ray tube (CRT), lens, meter front cover, aperture plate, headlight cover, show window, etc., but in the “antireflection film having a fine structure on the surface” of the above-mentioned (c), further improvement in the surface physical properties is necessary for the practical use.

### PRIOR ART DOCUMENTS

### Patent Documents

Patent Document 1: JP 550-070040A
Patent Document 2: JP H9-193332A
Patent Document 3: JP 2003-043203A
Patent Document 4: JP 2003-162205A
Patent Document 5: JP 2003-215314A
Patent Document 6: JP 2003-240903A
Patent Document 7: JP 2004-004515A
Patent Document 8: JP 2004-059820A
Patent Document 9: JP 2004-059822A
Patent Document 10: JP 2005-010231A
Patent Document 11: JP 2005-092099A
Patent Document 12: JP 2005-156695A
Patent Document 13: JP 2007-086283A
Patent Document 14: WO 2007/040159A
Patent Document 15: JP 2009-288337A
Patent Document 16: JP 2008-158293A

### SUMMARY OF THE INVENTION

### Problems to be Solved by the Invention

In flat panel displays (hereinafter abbreviated to as “FPD”) such as liquid crystal displays (LCD) and plasma displays (PDP), attachment of the antireflection film is essential to ensure its visibility. Also, in lens, a meter front cover, an aperture plate, a headlight cover, a show window, a cover for a frame or an exhibition case, etc., it has been desired to provide antireflection performance.

As a structure to be used for such a use, the inorganic or organic multilayer films shown in the above described (a) or (b), and the antireflection film having the fine surface structure in the above described (c) have been known. Among these, it has been known that the structure having a fine surface structure of (c) has a particularly excellent antireflection function.

However, for the structure having the fine surface structure (c), its preferred shape (structure) possessed by the surface has been significantly investigated as well as an optical theory such as a theory of reflection or transmission of light. However, the material to form the shape (structure) has not yet been investigated, and accordingly, properties such as mechanical characteristics of the surface, difficulty in adhering a stain, easiness in wiping a stain, etc., are particularly insufficient, so that it has not yet been practically used.

Further, even if it is indiscriminately said that “mechanical characteristics are to be improved”, “a stain is made difficulty adhered”, “a stain is made easily wiped away”, etc., of the surface of the structure having a specific fine surface structure, it has not yet been known how we should make general physical properties (basic physical properties) of the surface, materials of the structure, and the physical properties of the materials of the structure, etc.

That is, an object of the present invention is to find not only a surface shape, but also physical properties of the surface required for the structure having an antireflection performance of the light and an improved performance of light permeability, and especially, to provide the structure having good mechanical strength such as surface scratch resistance, etc., and being provided the properties such as difficulty in adhering a stain, easiness in wiping a stain. Also, the object is to provide a material which can form the structure having such a specific surface shape and physical properties.

### Means to Solve the Problems

The present inventors have extensively studied to solve the above-mentioned problems, and as a result, they have found that the above-mentioned problems can be solved when a structure having a particular surface shape is formed by polymerizing a polymerizable composition containing a specific component, to have a specific storage elastic modulus, whereby the above problems can be solved.

That is, they have found out that hydrophilic property of the surface of the structure is increased by using a specific amount of a (meth)acrylate compound having hydrophilic property as a material of the structure; further, folding of fine surface structure or damaging the surface can be prevented due to flexibility of the structure to which a stress is applied, by making flexible the storage elastic modulus of the structure within a specific range, releasability from a mold is improved; and as a result, properties such as mechanical strength such as surface scratch resistance, etc., difficulty in adhering a stain, easiness in wiping a stain, etc., can be rather provided to the surface of the structure, surprisingly; moreover, in a method for producing the structure by supplying a polymerizable composition to a mold with a specific shape, contact bonding a substrate from thereon, and after curing the polymerizable composition, releasing it from the mold, releasability from the mold is improved whereby they have accomplished the present invention.

Also, it could be found out that, if the physical properties of the surface of the structure where the polymerizable composition has been cured are changed by further adding a fluorine series surfactant to the composition, properties such as mechanical strength including surface scratch resistance, etc., difficulty in adhering a stain and easiness in wiping a stain, etc., could be further synergistically provided to the surface of the structure, and the above-mentioned mold releasability could be further improved.

That is, the present invention provides a structure having convex parts with an average height of 100 nm or more and 1000 nm or less, or concave parts with an average depth of 100 nm or more and 1000 nm or less on a surface thereof, wherein the convex parts or the concave parts thereof are present at an average cycle of 50 nm or more and 400 nm or less in at least a certain direction, the structure is obtained by polymerizing a polymerizable composition containing a (meth)acrylate compound by light irradiation, electron beam irradiation and/or heating, the (meth)acrylate compound contains 53% by mass or more polyethylene glycol di(meth)acrylate based on the whole (meth)acrylate compound, and the structure has a storage elastic modulus at 25° C. of 2 GPa or less and/or a storage elastic modulus at 180° C. of less than 0.5 GPa.

Also, the present invention is to provide the above-mentioned structure wherein the polyethylene glycol di(meth)acrylate is a material represented by the following formula (1).

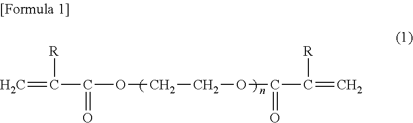

[in the formula (1), R represents a hydrogen atom or a methyl group, n represents a number of recurring units, and a number of 4 or more and 40 or less in an average value.]

Also, the present invention is to provide the above-mentioned structure, wherein the (meth)acrylate compound further contains an urethane (meth)acrylate.

Further, the present invention is to provide the above-mentioned structure, wherein the urethane (meth)acrylate contains tetra-functional or more of an urethane (meth)acrylate, and the tetra-functional or more of the urethane (meth)acrylate contains a material obtained by reacting a hydroxyl group of a compound having one hydroxyl group and two or more (meth)acryl groups in the molecule with substantially all the isocyanate groups of a polyvalent isocyanate compound.

Moreover, the present invention is to provide the above-mentioned structure, wherein the polymerizable composition further contains a fluorine series surfactant having an alkylene oxide recurring structure and a fluoroalkyl group.

Furthermore, the present invention is to provide the above-mentioned structure, wherein a carbon number of the fluoroalkyl group is 2 or more and 18 or less.

In addition, the present invention is to provide the above-mentioned structure, wherein the fluoroalkyl group is a perfluoroalkyl group.

Also, the present invention is to provide the above-mentioned structure, wherein a number of recurring units of the alkylene oxide recurring structure is 4 or more and 20 or less.

Further, the present invention is to provide the above-mentioned structure, wherein the fluorine series surfactant having the alkylene oxide recurring structure and the fluoroalkyl group is represented by the following formula (F).

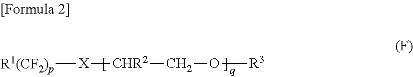

[in the formula (F), R¹ represents H or F, R² represents H or CH₃, R³ represents H or CH₃, X represents a divalent linking group, p is an integer of 2 or more and 18 or less, and q is an integer of 4 or more and 20 or less.]

Moreover, the present invention is to provide the above-mentioned structure, wherein the structure has a surface having a contact angle of water at 20° C. of 35° or less.

In addition, the present invention is to provide the above-mentioned structure, which is for antireflection of light and/or improvement of transmission of light.

The present invention also provides a method for producing the above-mentioned structure, which comprises supplying a polymerizable composition to a mold having concave parts with an average height of 100 nm or more and 1000 nm or less or convex parts an average depth of 100 nm or more and 1000 nm or less at a surface thereof, wherein the convex parts or the concave parts thereof are present at an average cycle of 50 nm or more and 400 nm or less in at least one direction, contact bonding a substrate from thereon, curing the polymerizable composition, and peeling the structure from the mold.

Further, the present invention is to provide the above-mentioned method for producing the above-mentioned structure, wherein the above-mentioned polymerizable composition further contains a fluorine series surfactant having an alkylene oxide recurring structure and a fluoroalkyl group.

Moreover, the present invention is to provide a polymerizable composition for forming the above-mentioned structure, which comprises a (meth)acrylate compound, and the (meth)acrylate compound contains 53% by mass or more of a polyethylene glycol di(meth)acrylate based on the whole (meth)acrylate compound.

Furthermore, the present invention is to provide the above-mentioned polymerizable composition, wherein the polymerizable composition further contains a fluorine series surfactant having an alkylene oxide recurring structure and a fluoroalkyl group.

In addition, the present invention is to provide a material for forming an antireflection member comprising the above-mentioned polymerizable composition for forming the structure, wherein the polymerizable composition contains a (meth)acrylate compound, and the (meth)acrylate compound contains 53% by mass or more of a polyethylene glycol di(meth)acrylate based on the whole (meth)acrylate compound.

The present invention is also to provide the above-mentioned material for forming an antireflection member, wherein the above-mentioned polymerizable composition further contains a fluorine series surfactant having an alkylene oxide recurring structure and a fluoroalkyl group.

### Effects of the Invention

According to the present invention, it is possible to provide the structure which is excellent not only in optical properties such as an antireflection performance of the light and an improved performance of light permeability, etc., but also in mechanical strength such as surface scratch resistance, etc., and further excellent in the properties such as difficulty in adhering a stain, easiness in wiping a stain (contamination resistance), and releasability from a mold, etc.

### BRIEF EXPLANATION OF THE DRAWINGS

FIG. 1 is a schematic view showing an example of the method for producing a structure of the present invention.

FIG. 2 is a schematic view showing an example of a continuous production apparatus for illustrating the method for producing the structure of the present invention.

### EMBODIMENTS TO CARRY OUT THE INVENTION

### 1. Shape of Structure Surface

In the structure of the present invention, it is essential to have convex parts with an average height of 100 nm or more and 1000 nm or less or concave parts with an average depth of 100 nm or more and 1000 nm or less on a surface thereof. Here, the convex part refers to a part which projects from a surface which becomes a standard, and the concave part refers to a part which recesses from the surface which becomes a standard. The structure of the present invention may have the convex parts or the concave parts on the surface thereof. Also, the structure may have both of the convex parts and the concave parts, and further these may be linked to form a wavy structure.

The above-mentioned convex parts or the concave parts may exist at least a part of the structure. When the structure is a material having a platy or film shape, they may exist at the both surfaces of the structure and it is essential that they exist at least a part of at least one surface. When the structure is a platy state or a film state material, these parts may exist on the both surfaces of the structure, and it is essential to have the parts at least a part of at least one surface. When the structure is a platy state or a film state material, it is preferred to have the parts at substantially the whole surface of one of the surfaces.

Among these, it is preferred to have the convex parts or the concave parts on an outermost surface of the structure in contact with air. The air is largely different in refractive index from the structure of the present invention, and the antireflection performance and the improved performance of light permeability can be achieved well by making an interface of substances having different refractive index with each other a particular structure of the present invention. Also, by being present the structure of the present invention on the outermost surface to which a mechanical external force is easily given, the effects of the present invention are achieved, and scratch resistance and contamination resistance, etc., of the surface are improved.

It is preferred for achieving the above effects that the convex parts or the concave parts are present uniformly on the entire surface of at least one of the structure. In the case of the convex parts, it is essential that the average height from the standard face is 100 nm or more and 1000 nm or less. In the case of the concave parts, it is essential that the average depth from the standard face is 100 nm or more and 1000 nm or less. The height or the depth may not be constant. It is sufficient if their average values are within the above-mentioned ranges, and it is preferred that they have substantially an almost constant height or constant depth.

In either of the case of the convex parts or the case of the concave parts, the average height or the average depth is preferably 120 nm or more, and particularly preferably 150 nm or more. Also, the upper limit is preferably 700 nm or less, more preferably 500 nm or less, and particularly preferably 350 nm or less. If the average height or the average depth is too small, good optical characteristics cannot be obtained in some cases, while if it is too large, manufacture thereof becomes difficult in some cases.

When the surface of the structure is linked to have a wavy structure, it is to be decided that the convex parts are present or the concave parts are present on the whole surface. That is, the surface which becomes the standard is to be decided to take the surface formed by substantially the highest portion or to take the surface formed by substantially the deepest portion. Based on the above, with regard to the range of the present invention, it is essential that the average length from the highest portion to the deepest portion is 100 nm or more and 1000 nm or less by the same reasons as mentioned above, preferably 120 nm to 700 nm, more preferably 150 nm to 500 nm, particularly preferably 150 nm to 350 nm.

In the structure of the present invention, it is essential that the above convex parts or the concave parts are present to at least a certain direction with the average cycle of 50 nm or more and 400 nm or less. The convex parts or the concave parts may be arranged at random, or arranged with regularity. Also, in either of the cases, it is preferred in the points of an antireflection property and an improved performance of light permeability that the above convex parts or the concave parts are provided on the surface of the structure substantially uniformly on the surface of the structure. Also, it may be arranged so that the average cycle becomes 50 nm or more and 400 nm or less for at least a certain direction, and it is not necessary to be the average cycle of 50 nm or more and 400 nm or less for all the directions.

When the convex parts or the concave parts are arranged with regularity, they may be so arranged that the average cycle to at least a certain direction becomes 50 nm or more and 400 nm or less, and it is preferred to be arranged so that the cycle to the direction at which the cycle is the shortest (hereinafter referred to as an “x axis direction”) is 50 nm or more and 400 nm or less. That is, it is preferred that the cycle is within the above-mentioned range when the certain direction is made the direction at which the cycle is the shortest.

The above-mentioned average cycle (it is “the cycle” when the arranged place of the convex parts or the concave parts has a regularity) is preferably 70 nm or more, more preferably 100 nm or more, particularly preferably 120 nm or more, further preferably 150 nm or more. In addition, it is preferably 300 nm or less, more preferably 250 nm or less, particularly preferably 200 nm or less. If the average cycle is too short or too long, there is a case where the antireflection effect cannot be sufficiently obtained.

In the structure of the present invention, it has the above-mentioned structure on the surface thereof, and it is preferred to have the structure generally called to as “moth eye structure (structure of eyes of a moth)” in the point of having good antireflection performance. In addition, it is also preferred that it has the surface structure disclosed in any of Patent Document 1 to Patent Document 15 similarly in the point of obtaining good antireflection performance.

The aspect ratio which is a value obtained by dividing the height or the depth by the average cycle is not particularly limited, and is preferably 1 or more in the point of optical characteristics, more preferably 1.5 or more, particularly preferably 2 or more. It is also preferably 5 or less in view of a manufacturing process of the structure, particularly preferably 3 or less. By polymerizing the polymerizable composition of the present invention, the structure having a large aspect ratio (for example, 1.5 or more) can be suitably formed. Accordingly, in order to exert the characteristics of the (meth)acrylic polymerizable composition of the present invention, the larger aspect ratio is more preferred, and it is particularly preferably 1.5 or more, further preferably 2 or more.

The structure of the present invention reduces the reflectance of the light or enhances a performance of light permeability by being provided the above-mentioned structure on the surface. The “light” in this case means a light including at least the light having a wavelength at the visible light region.

### 2. Constitution and Forming Method of the Structure

Further, it is essential that the structure of the present invention comprises a material in which a polymerizable composition containing a (meth)acrylate compound is polymerized by light irradiation, electron beam irradiation and/or heating. That is, the structure of the present invention is formed by reacting the carbon-carbon double bonds of the (meth)acryl groups of the (meth)acrylate compounds in the polymerizable composition by light irradiation, electron beam irradiation and/or heating. In the present invention, “(meth)acryl” means “acryl” or “methacryl”.

“By light irradiation, electron beam irradiation and/or heating” may be by any one treatment selected from the group consisting of the light irradiation, the electron beam irradiation and the heating, any two treatment selected therefrom in combination, or a combination of all the three treatments.

Among these, it is preferred to cure (polymerize) the composition by ultraviolet irradiation in the light irradiation in the points of a cost of an irradiation device, a rate of spread, a time required for the curing (line speed), etc.

The structure of the present invention is obtained by reacting the carbon-carbon double bond of the (meth)acryl group in the polymerizable composition which becomes a material thereof. Their reaction rate is not particularly limited, but is preferably 70% or more, more preferably 85% or more and particularly preferably 90% or more based on the whole carbon-carbon double bonds. Here, the “reaction rate” is calculated from a ratio of an absorbance at 1720 cm⁻¹ attributed to carbon-oxygen bonds of ester bonds to an absorbance at 810 cm⁻¹ attributed to carbon-carbon bonds, which are measured the (meth)acrylic polymerizable composition before and after the reaction by an infrared spectrophotometer (IR), specifically by an attenuated total reflection method (ATR method) using a Fourier transform infrared spectrophotometer, Spectrum One D (supplied from Perkin Elmer Inc.).

If the reaction rate is too low, it sometimes causes lowering in mechanical strength or lowering in chemical resistance.

### 3. Material for Forming the Structure (Polymerizable Composition)

When the structure of the present invention having the specific surface structure as mentioned above is formed from the following mentioned materials (the polymerizable composition), the resulting material is excellent in optical properties such as an antireflection performance of the light, and an improved performance of light permeability, etc., in particular, excellent in properties such as mechanical strength such as surface scratch resistance, etc.; properties such as difficulty in adhering a stain or easiness in wiping a stain by wiping with water (contamination resistance); etc.

That is, the structure of the present invention is a material in which the polymerizable composition containing a (meth)acrylate compound has been polymerized, the (meth)acrylate compound contains 53% by mass or more of a polyethylene glycol di(meth)acrylate based on the whole (meth)acrylate compound, and the structure has a storage elastic modulus at 25° C. of 2 GPa or less and/or a storage elastic modulus at 180° C. of less than 0.5 GPa. In the following, the materials for the structure of the present invention are explained in detail.

The structure of the present invention is formed by polymerizing “the polymerizable composition containing a (meth)acrylate compound”. It is essential that the “polymerizable composition” contains a (meth)acrylate compound, and further preferably contains a fluorine series surfactant to achieve the above-mentioned effects, and particularly preferably contains a fluorine series surfactant having an alkylene oxide recurring structure and a fluoroalkyl group to achieve the above-mentioned effects.

To the “polymerizable composition”, a polymerization initiator such as a photopolymerization initiator, a thermal polymerization initiator, etc.; a binder polymer; fine particles; an antioxidant; an ultraviolet absorbing agent; a photostabilizer; a defoaming agent; a mold-releasing agent; a lubricant; a leveling agent, etc., may be added as other components. In the components of the polymerizable composition, those which are merely incorporated into inside thereof by polymerization of the (meth)acrylate compound but do not directly participate in the polymerization are also included.

### 3-1. (Meth)Acrylate Compound

The polymerizable composition of the present invention contains a (meth)acrylate compound as an essential component.

### 3-1-1. Polyethylene Glycol Di(Meth)Acrylate

The polymerizable composition of the present invention contains a (meth)acrylate compound as an essential component, and it is also essential that the (meth)acrylate compound contains 53% by mass or more of a polyethylene glycol di(meth)acrylate based on the whole (meth)acrylate compound. By using 53% by mass or more of the polyethylene glycol di(meth)acrylate based on the whole (meth)acrylate compound, the surface of the structure becomes difficulty damaged, a stain becomes difficulty attached or a stain can be easily wiped away.

In addition, hydrophilicity is well provided to the surface of the structure having the above-mentioned specific fine structure, and even if a reaction rate of the carbon-carbon double bonds, i.e., the polymerization degree is sufficiently increased, the storage elastic modulus at 25° C. and/or 180° C. can be easily contained in a suitable range. According to the above, in particular, an optical property such as an antireflection performance of the light and an improved performance of light permeability, etc.; mechanical strength such as surface scratch resistance, etc.; and difficulty in adhering a stain or easiness in wiping a stain by wiping with water (hereinafter sometimes abbreviated to “contamination resistance”); etc., of the obtained structure become extremely excellent.

It is essential to contain the polyethylene glycol di(meth)acrylate in an amount of 53% by mass or more based on the whole (meth)acrylate compound, more preferably 55% by mass or more is contained, and particularly preferably 60% by mass or more is contained, and further preferably 65% by mass or more is contained. There is no particular limit about the upper limit, and preferably 95% by mass or less is contained, particularly preferably 90% by mass or less is contained, further preferably 85% by mass or less is contained. When the polyethylene glycol di(meth)acrylate is used in combination of two or more kinds, the above-mentioned range is a total amount of the same.

Incidentally, the above-mentioned % by mass is each % by mass of a single material in both of the polyethylene glycol di(meth)acrylate and the (meth)acrylate compound other than the same (co-presenting (meth)acrylate compound) in the polymerizable composition. For example, these compounds are frequently obtained or used as a solution, and in these cases, it is % by mass in terms of the compound itself, and the solvent is excluded from the calculation of % by mass. This is the same in the following.

If the contained ratio of the polyethylene glycol di(meth)acrylate is too little based on the whole (meth)acrylate compound, hydrophilicity is not suitably provided to the surface of the obtained structure having the above-mentioned specific fine structure, or storage elastic modulus at 25° C. and/or 180° C. of the obtained structure cannot be included in the suitable range in some cases. Also, as a result, there is a case where mechanical strength such as surface scratch resistance, etc.; difficulty in adhering a stain or easiness in wiping a stain by wiping with water (contamination resistance); etc. cannot be sufficiently accomplished.

On the other hand, if the contained ratio of the polyethylene glycol di(meth)acrylate is too much, there are effects for improving hydrophilic property or improving contamination resistance, but mechanical strength such as surface scratch resistance, etc., is lowered in some cases.

Incidentally, the above-mentioned % by mass is each % by mass of a single material in both of the polyethylene glycol di(meth)acrylate and the (meth)acrylate compound other than the polyethylene glycol di(meth)acrylate in the polymerizable composition. For example, these compounds are frequently obtained or used as a solution, and in these cases, it is % by mass in terms of the compound itself, and the solvent is excluded from the calculation of % by mass. When the compound itself is a solid, it is % by mass in terms of a solid.

A length of the ethylene glycol chain of the polyethylene glycol di(meth)acrylate is not particularly limited, and as the “—CH₂CH₂O—” is counted as 1 unit, and it is preferably, in average, 4 units to 40 units (an average value of n in the formula (1) of 4 to 40), more preferably 6 units to 32 units (an average value of n in the formula (1) of 6 to 32), particularly preferably 8 units to 25 units (an average value of n in the formula (1) of 8 to 25), further preferably 12 units to 20 units (an average value of n in the formula (1) of 12 to 20). If the ethylene glycol chain is too short or too long, there is a case where hydrophilicity cannot be provided to the surface of the structure with good extent.

Also, if the ethylene glycol chain is too short, there are cases where storage elastic modulus at 25° C. becomes too large, or hydrophilic property cannot be provided (contact angle becomes too large), while if it is too long, there are cases where curability becomes bad, storage elastic modulus at 25° C. becomes too small, or low temperature stability becomes bad to cause crystallization.

As a result, if the ethylene glycol chain is too short or too long, there is a case where mechanical strength such as surface scratch resistance, etc.; and properties such as difficulty in adhering a stain or easiness in wiping a stain by wiping with water (contamination resistance); etc., cannot be sufficiently achieved, and an extremely excellent material cannot be necessarily obtained.

That is, when the above-mentioned polyethylene glycol di(meth)acrylate is represented by the following formula (1), the above-mentioned effects can be remarkably achieved. That is, when a number of the (recurring) units is 8 units to 25 units in an average value, it is particularly preferred by the reasons as mentioned above.

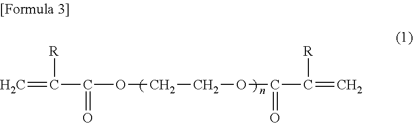

[in the formula (1), R represents a hydrogen atom or a methyl group, n represents a number of recurring units, and a number of 4 or more to 40 or less in an average value.]

The polyethylene glycol di(meth)acrylates having different number of the (recurring) units may be used one kind alone or two or more kinds in combination. When two or more kinds thereof are to be used, it is essential that the total amount thereof is 53% by mass or more.

Each of the (meth)acrylate compound and the polyethylene glycol di(meth)acrylate contained therein may be either an acrylate or a methacrylate, and an acrylate is preferred in the points that polymerizability is good and adjustment of the mechanical strength of the cured film can be easily carried out.

In the present invention, a polypropylene glycol di(meth)acrylate is not excluded from the (meth)acrylate compound, but the polyethylene glycol di(meth)acrylate gives a product having markedly superior properties than those of the polypropylene glycol di(meth)acrylate. It is the characteristic feature that the present invention contains the polyethylene glycol di(meth)acrylate in an amount of 53% by mass or more based on the whole (meth)acrylate compound.

In the present invention, it is essential that the above-mentioned structure has a storage elastic modulus at 25° C. of 2 GPa or less and/or a storage elastic modulus at 180° C. of less than 0.5 GPa. To make the storage elastic modulus in the above range, a kind and an amount of the polyethylene glycol di(meth)acrylate to be used as well as a composition and a formulation ratio of the polymerizable composition, etc., are to be set.

By making the storage elastic modulus of the structure within the above-mentioned range, remarkable effects can be achieved that the surface of the structure becomes difficulty damaged, a stain becomes difficulty attached or a stain can be easily wiped away, and mold releasability at the time of peeling off from the mold is improved.

Since the structure is flexible, it can be prevented that the fine surface structure is folded when a stress is applied thereto, whereby damages caused. As a result, mechanical strength such as surface scratch resistance, etc., difficulty in adhering a stain, easiness in wiping a stain (for example, a property in which a stain is wiped away by wiping with water), etc., can be provided to the surface of the structure. With regard to the storage elastic modulus, it will be mentioned in detail below.

In the present invention, a fluorine series surfactant mentioned hereinbelow, in particular, “a fluorine series surfactant having an alkylene oxide recurring structure and a fluoroalkyl group” is further contained in the above-mentioned polymerizable composition, according to the synergistic effect of the polyethylene glycol di(meth)acrylate and the fluorine series surfactant, remarkable effects that the surface of the structure becomes difficulty damaged, and in particular, a stain becomes difficulty attached or a stain can be particularly easily wiped away, can be achieved.

The polyethylene glycol di(meth)acrylate may be specifically mentioned, for example, ethylene glycol di(meth)acrylate such as diethylene glycol di(meth)acrylate, triethylene glycol di(meth)acrylate, tetraethylene glycol di(meth)acrylate, polyethylene glycol #200 di(meth)acrylate, polyethylene glycol #400 di(meth)acrylate, polyethylene glycol #600 di(meth)acrylate, polyethylene glycol #1000 di(meth)acrylate, polyethylene glycol #1200 di(meth)acrylate, polyethylene glycol #1540 di(meth)acrylate, polyethylene glycol #2000 di(meth)acrylate, etc.

In addition, it is not limited to the above-mentioned “#200”, “#400”, “#600”, “#1000”, “#1200” and “#1540”, and polyethylene glycol di(meth)acrylate in the range of #200-#2000 may be mentioned as specific examples.

Here, for example, “#200”, etc., correlates to a number of recurring units of the polyethylene glycol chain, and “—CH₂CH₂O—” as 1 unit, “#200” means 4 units, “#400” 8 units, “#600” 12 units, “#1000” 20 units, “#1540” 32 units, and “#2000” 40 units.

### 3-1-2. Urethane (Meth)Acrylate

In the (meth)acrylate compound in the present invention, it is preferred to further contain an urethane (meth)acrylate. The “urethane (meth)acrylate” means a (meth)acrylate compound having an urethane bond in the molecule.

The urethane (meth)acrylate to be used in the present invention is not particularly limited in, for example, the position and a number of the urethane bond(s), and the position and a number of the (meth)acryl group(s).

A preferred chemical structure of the urethane (meth)acrylate to be used for forming the structure of the present invention may be mentioned (A) those having a structure obtained by reacting a compound having a hydroxyl group and a (preferably a plural number of) (meth)acryl group(s) in the molecule with a compound having an (preferably a plural number of) isocyanate group(s) in the molecule, and (B) those having a structure obtained by reacting a diisocyanate compound or a triisocyanate compound with a compound having a plural number of hydroxyl groups, and further reacting an unreacted isocyanate group of the obtained compound with a compound having a hydroxyl group and a (meth)acryl group in the molecule such as hydroxyethyl(meth)acrylate, etc.

When the above-mentioned (meth)acrylate compound contains an urethane (meth)acrylate, curability and the reaction rate are increased, and the storage elastic modulus at 25° C. and/or 180° C. of the obtained structure can be included in the preferred range. In addition, the obtained structure becomes a material excellent in flexibility, and mechanical strength such as surface scratch resistance, etc., and contamination resistance, etc., can be sufficiently accomplished.

The urethane (meth)acrylate may be suitably used either of a tri-functional or more urethane (meth)acrylate, or a bi-functional or less urethane (meth)acrylate. Also, the urethane (meth)acrylate may be used a single kind or two or more kinds in combination.

The chemical structure of such an urethane (meth)acrylate is not particularly limited, and a weight average molecular weight thereof is preferably 1,000 or more and 30,000 or less, more preferably 1,500 or more and 15,000 or less, particularly preferably 2,000 or more and 5,000 or less. If the molecular weight is too small, flexibility is lowered in some cases.

### [Tri-Functional or More Urethane (Meth)Acrylate]

It is preferred to contain a tri-functional or more (particularly preferably tetra-functional or more) urethane (meth)acrylate as the urethane (meth)acrylate. That is, it is preferred to contain a compound having 3 or more (particularly preferably 4 or more) (meth)acryl groups in the molecule.

It is not particularly limited about the positions or a number of the urethane bonds at this time, and whether the (meth)acryl groups are at the ends of the molecules or not. A compound having 6 or more (meth)acryl groups in the molecule is particularly preferred, and a compound having 9 or more of the same is further preferred. Also, an upper limit of the number of the (meth)acryl groups in the molecule is not particularly limited, and it is particularly preferably 15 or less.

If a number of the (meth)acryl groups in the urethane (meth)acrylate molecule is too little, cross-linking density or curability of the obtained structure becomes low, and the storage elastic modulus at 25° C. and/or 180° C. becomes too low, whereby the structure becomes too soft in some cases, and further, sufficient mechanical strength cannot be obtained in some cases as the surface scratch resistance is inferior.

On the other hand, if a number of the (meth)acryl groups in the urethane (meth)acrylate molecule is too much, cross-linking density or curability of the obtained structure becomes high, but sufficient mechanical strength cannot be obtained in some cases as the storage elastic modulus at 25° C. and/or 180° C. becomes too high, or the film quality of the structure becomes too brittle, and surface scratch resistance is inferior, etc.

If the (meth)acrylate compound contains the polyethylene glycol di(meth)acrylate and the urethane (meth)acrylate, curability and flexibility are improved by their synergistic effects, and as a result, mechanical strength such as surface scratch resistance, etc., or contamination resistance can be sufficiently accomplished.

Also, if a fluorine series surfactant (in particular, a fluorine series surfactant having an alkylene oxide recurring structure and a fluoroalkyl group) is further contained therein, in particular, curability and flexibility are improved by their synergistic effects, and as a result, mechanical strength such as surface scratch resistance, etc., or contamination resistance can be extremely suitably accomplished.

The tri-functional or more (preferably tetra-functional or more) of the urethane (meth)acrylate is preferably contained in the above-mentioned (meth)acrylate compound in an amount of 10% by mass or more, more preferably 20% by mass or more, particularly preferably 30% by mass or more, and preferably less than 47% by mass. If the amount is within the above-mentioned range, curability and flexibility are excellent and scratch resistance becomes good.

The chemical structure of the tri-functional or more of the urethane (meth)acrylate is not particularly limited, and it is preferred that the urethane (meth)acrylate is obtained by reacting a hydroxyl group of the compound (b) having a hydroxyl group and 2 or more (meth)acryl groups in the molecule with an isocyanate group of the polyvalent isocyanate compound (a).

The tetra-functional or more of the urethane (meth)acrylate also has the same chemical structure as mentioned above.

A number of the isocyanate groups possessed by the above-mentioned polyvalent isocyanate compound (a) is preferably 2 to 6, and particularly preferably 2 to 3. If it is less than the above-mentioned range, there is a case where flexibility is insufficient, while if it is larger than the above-mentioned range, there is a case where the resulting material is too soft or a viscosity of the polymerizable composition becomes too high.

The above-mentioned polyvalent isocyanate compound (a) is not particularly limited, and may be mentioned a compound having two or more isocyanate groups in the molecule. The compound having two or more isocyanate groups in the molecule may be mentioned, for example, 1,5-naphthylene diisocyanate, 4,4′-diphenylmethane diisocyanate, hydrogenated diphenylmethane diisocyanate, 1,3-phenylene diisocyanate, 1,4-phenylene diisocyanate, tolylene diisocyanate, butane-1,4-diisocyanate, hexamethylene diisocyanate, 2,2,4-trimethylhexamethylene diisocyanate, 2,4,4-trimethylhexamethylene diisocyanate, cyclohexane-1,4-diisocyanate, xylylene diisocyanate, isophorone diisocyanate, lysine diisocyanate, dicyclohexylmethane-4,4′-diisocyanate, 1,3-bis(isocyanatomethyl)cyclohexane, methylcyclohexane diisocyanate, and m-tetramethylxylylene diisocyanate, etc.

Also, the compound having three isocyanate groups in the molecule may be mentioned, for example, “trimethylol propane addition adduct products, biuret products, and isocyanurate products in which a 6-membered ring is formed by trimerization, which are obtained by modifying isophorone diisocyanate, tolylene diisocyanate, hexamethylene diisocyanate or xylylene diisocyanate”, etc.

The bi-functional isocyanate which is a starting material of the isocyanurate product is not particularly limited, and in the present invention, an isocyanurate product of isophorone diisocyanate, tolylene diisocyanate or hexamethylene diisocyanate (HDI) is more preferred, and an isocyanurate product in which hexamethylene diisocyanates (HDI) are trimerized is particularly preferred in the points that it has a distance between the functional groups and has a structure which can provide flexibility.

The compound (b) having one hydroxyl group and two or more (meth)acryl groups in the molecule is not particularly limited, and may be mentioned a compound obtained by reacting (p-1) (meth)acrylic acids to the hydroxyl groups of a compound (b-1) having three or more (which is made p) hydroxyl groups; and a compound obtained by ring-opening reaction of glycidyl (meth)acrylate and (meth)acrylic acid, etc.

Here, the “compound (b) having one hydroxyl group and two or more (meth)acryl groups in the molecule” also includes the case where a compound having two or more hydroxyl groups in the molecule is migrated and the case where a compound having one (meth)acryl group is migrated when the compound is produced by partially reacting two or more kinds of compounds.

Among the compound (b), the “compound (b-1) having 3 or more hydroxyl groups in the molecule” in the “compound in which (p-1) (meth)acrylic acids are reacted with the compound (b-1) having p (p is an integer of 3 or more) hydroxyl groups in the molecule” is not particularly limited, and there may be mentioned, for example, glycerin, trimethylolethane, trimethylolpropane, pentaerythritol, tetramethylolethane, diglycerin, ditrimethylolethane, ditrimethylolpropane, dipentaerythritol and ditetramethylolethane; an ethylene oxide-modified compound thereof; a propylene oxide-modified compound thereof; compounds of isocyanuric acid modified by ethylene oxide, modified by propylene oxide or modified by ∈-caprolactone; and oligo ester, etc.

A number of the hydroxyl groups in the compound (b-1) is particularly preferably 4 or more since a number of the functional groups in the resulting urethane (meth)acrylate can be made larger. That is, the compound (b-1) may be specifically mentioned, for example, pentaerythritol, tetramethylolethane, diglycerin, ditrimethylolethane, ditrimethylolpropane, dipentaerythritol, ditetramethylolethane, etc., as particularly preferred ones.

Taking diglycerin as an example, by reacting (meth)acrylic acid with three hydroxyl groups among the four hydroxyl groups of diglycerin, a compound (b) having a hydroxyl group and two or more (in this case, three) (meth)acryl groups in the molecule can be synthesized. Further, taking the case where the polyvalent isocyanate compound (a) is isophorone diisocyanate as an example, the above-mentioned two compounds (b) having a hydroxyl group and two or more (meth)acryl groups are reacted with two isocyanate groups of isophorone diisocyanate so that “tetra-functional or more urethane (meth)acrylate” can be synthesized. At this time, when a compound (b) having a hydroxyl group and three (meth)acryl groups in the molecule is reacted with isophorone diisocyanate, a “tetra-functional or more urethane (meth)acrylate” having six (meth)acryl groups in the molecule is consequently synthesized.

### [Bi-Functional or Lower Urethane (Meth)Acrylate]

The urethane (meth)acrylate may be an urethane (meth)acrylate of tri-functional or lower. The chemical structure of such an urethane (meth)acrylate or tri-functional or lower is not particularly limited, and those conventionally known can be used.

The bi-functional or lower urethane (meth)acrylate may be mentioned a bi-functional urethane (meth)acrylate having each one (meth)acryl group at the both ends of the molecule. The chemical structure of such a bi-functional urethane (meth)acrylate is not particularly limited.

### 3-1-3. Polyol (Meth)Acrylate

The (meth)acrylate compound for forming the structure of the present invention may contain a polyol (meth)acrylate. The “polyol (meth)acrylate” in the present invention means a material obtained by dehydration condensation reaction of an alcohol and (meth)acrylic acid, etc., which does not have both of a urethane bond and a siloxane bond, and is referred to the material other than the above-mentioned polyethylene glycol di(meth)acrylate.

The bi-functional polyol (meth)acrylate may be mentioned, for example, a linear alkane diol di(meth)acrylate such as 1,4-butanediol di(meth)acrylate, 1,6-hexanediol di(meth)acrylate, 1,9-nonanediol di(meth)acrylate, etc.; an alkylene glycol di(meth)acrylate such as dipropylene glycol di(meth)acrylate, tripropylene glycol di(meth)acrylate, tetrapropylene glycol di(meth)acrylate, polypropylene glycol #400 di(meth)acrylate, polypropylene glycol #700 di(meth)acrylate, etc.; a partial (meth)acrylic acid ester of tri-valent or more of an alcohol such as pentaerythritol di(meth)acrylate, pentaerythritol di(meth)acrylate monostearate, pentaerythritol di(meth)acrylate monobenzoate, etc.; a bisphenol series di(meth)acrylate such as bisphenol A di(meth)acrylate, EO-modified bisphenol A di(meth)acrylate, PO-modified bisphenol A di(meth)acrylate, hydrogenated bisphenol A di(meth)acrylate, EO-modified hydrogenated bisphenol A di(meth)acrylate, PO-modified hydrogenated bisphenol A di(meth)acrylate, bisphenol F di(meth)acrylate, EO-modified bisphenol F di(meth)acrylate, PO-modified bisphenol F di(meth)acrylate, EO-modified tetrabromobisphenol A di(meth)acrylate, etc.; neopentyl glycol di(meth)acrylate, neopentyl glycol PO-modified di(meth)acrylate; hydroxypivalic acid neopentyl glycol ester di(meth)acrylate, hydroxy pivalic acid neopentyl glycol ester caprolactone-added di(meth)acrylate; 1,6-hexanediol bis(2-hydroxy-3-acryloyloxypropyl)ether; a di(meth)acrylate such as tricyclodecanedimethylol di(meth)acrylate, isocyanuric acid EO-modified di(meth)acrylate, etc.

Among these, a bi-functional polyol (meth)acrylate is preferred for providing flexibility and adjusting storage elastic modulus at 25° C. and/or 180° C.

The tri-functional polyol (meth)acrylate may be mentioned, for example, glycerin PO-modified tri(meth)acrylate, trimethylolpropane tri(meth)acrylate, trimethylolpropane EO-modified tri(meth)acrylate, trimethylolpropane PO-modified tri(meth)acrylate, isocyanuric acid EO-modified tri(meth)acrylate, isocyanuric acid EO-modified ∈-caprolactone-modified tri(meth)acrylate, 1,3,5-triacryloylhexahydro-s-triazine, pentaerythritol tri(meth)acrylate, dipentaerythritol tri(meth)acrylate tripropionate, etc.

The tetra-functional or more of the polyol (meth)acrylate may be mentioned, for example, pentaerythritol tetra(meth)acrylate, dipentaerythritol penta(meth)acrylate monopropionate, dipentaerythritol hexa(meth)acrylate, tetramethylolethane tetra(meth)acrylate, oligo ester tetra(meth)acrylate, etc. These may be used one kind alone or in admixture of two or more kinds.

If the tri-functional or more, or tetra-functional or more polyol (meth)acrylate is formulated, there is a case where a film quality (the structure) becomes too hard or storage elastic modulus at 25° C. and/or 180° C. becomes too high, and as a result, surface scratch resistance or contamination resistance becomes worse.

### 3-1-4. Epoxy (Meth)Acrylate

Also, the (meth)acrylic polymerizable composition of the present invention may contain an epoxy (meth)acrylate. The “epoxy (meth)acrylate” refers to a (meth)acrylate compound having a structure obtained by reacting (meth)acrylic acid with an epoxy group.

The “epoxy (meth)acrylate” has a rigid structure, and by formulating the same in the composition, a film quality (the structure) becomes brittle or storage elastic modulus at 25° C. and/or 180° C. becomes too high, and as a result, surface scratch resistance or contamination resistance becomes worse in some cases so that it is to be noted when it is used.

### 3-2. Fluorine Series Surfactant

The polymer composition of the present invention preferably further contains a fluorine series surfactant, and particularly preferably contains a fluorine series surfactant having an alkylene oxide recurring structure and a fluoroalkyl group. By using the fluorine series surfactant, the surface of the structure is more difficulty damaged (improved in surface scratch resistance), and it can be made more excellent in contamination resistance.

The “fluorine series surfactant” means a compound having a fluorine atom(s) and having a surface activity, and the chemical structure is not particularly limited so long as it contains a fluorine atom(s). If a compound where a group containing the fluorine atom is a hydrophobic group, to which a hydrophilic group is bonded to have a property as a surfactant, it is included in the present invention. The fluorine series surfactant in the present invention is preferably a material containing an alkylene oxide recurring structure and a fluoroalkyl group.

Such an “alkylene oxide” is particularly preferably ethylene oxide in the points of improvement in surface scratch resistance and improvement in contamination resistance.

The alkylene oxide recurring structure may be any material either having one kind of an alkylene oxide chain or having two or more kinds of alkylene oxide chains.

The number of the recurring units of the alkylene oxide recurring structure is preferably 4 or more and 20 or less, more preferably 4 or more and 16 or less, particularly preferably 4 or more and 12 or less.

A carbon number of the fluoroalkyl group is not particularly limited, and preferably 2 or more and 18 or less, more preferably 3 or more and 14 or less, particularly preferably 4 or more and 8 or less.

Also, the fluoroalkyl group is preferably a perfluoroalkyl group. That is, the fluorine series surfactant is particularly preferably a perfluoroalkylethylene oxide adduct.

A carbon number of the perfluoroalkyl group is not particularly limited, and preferably 2 or more and 18 or less, more preferably 3 or more and 14 or less, particularly preferably 4 or more and 8 or less.

With regard to the specific structure of the above-mentioned fluorine series surfactant, preferred is a material having a structure in which the alkylene oxide recurring structure and the fluoroalkyl group are serially connected, and a material having the structure represented by the following formula (F) in which the alkylene oxide recurring structure and the fluoroalkyl group are serially connected may be mentioned as a particularly preferred example of the fluorine series surfactant.

When the fluorine series surfactant represented by the following formula (1) is contained in the polymerizable composition, a structure having extremely excellent mechanical strength such as surface scratch resistance, etc., and contamination resistance, etc., can be obtained.

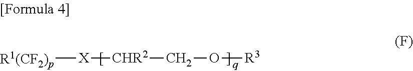

[in the formula (F), R¹ represents H or F, R² represents H or CH₃, R³ represents H or CH₃, X represents a divalent linking group, p is an integer of 2 or more and 18 or less, and q is an integer of 4 or more and 20 or less.]

In the formula (F), R¹ is preferably F, and R² is preferably H, in the points of surface scratch resistance, contamination resistance, etc., respectively.

In addition, p is preferably an integer of 3 or more and 14 or less in the points of surface scratch resistance, contamination resistance, etc., more preferably an integer of 4 or more and 10 or less, particularly preferably an integer of 6 or more and 8 or less.

q is preferably an integer of 4 or more and 16 or less in the points of surface scratch resistance, contamination resistance, etc., particularly preferably an integer of 5 or more and 10 or less.

Also, X represents a divalent linking group, more preferably a divalent linking group having 1 to 16 atoms including the hydrogen atom(s), and particularly preferably a divalent linking group having 1 to 10 atoms including the hydrogen atom(s). Also, it is preferably a divalent linking group having 1 to 6 atoms excluding the hydrogen atom(s), and particularly preferably a divalent linking group having 1 to 4 atoms excluding the hydrogen atom(s).

X is specifically mentioned, for example, “—Y—O—” (Y represents an alkylene group having 1 to 5 carbon atoms, preferably an ethylene group or a propylene group), “—O—” or “—COO—” which are preferred in the points of surface scratch resistance, contamination resistance, etc.

However, in recent years, perfluorooctanoic acid (PFOA) has high bioaccumulation potential so that the use thereof is now being regulated, so that if PFOA where p=7 and X is “—COO—” in the above-mentioned formula (F) is to be used as a starting material, there might be a problem from the viewpoint of practical use.

In the above-mentioned fluorine series surfactant, a perfluoroalkylethylene oxide adduct wherein R¹ in the formula (F) is F, a carbon number of the perfluoroalkyl group is 4 or more and 8 or less, R² in the formula (F) is H, and a number of the recurring unit of the ethylene oxide recurring structure is 4 or more and 12 or less.

A formulation amount of the above-mentioned fluorine series surfactant to be used is generally in the range of 0.1 to 10 parts by mass, preferably 0.3 to 5 parts by mass, particularly preferably 0.5 to 3 parts by mass based on 100 parts by mass of the (meth)acrylate compound.

If it is less than the above-mentioned range, abrasion resistance at the surface of the structure cannot sufficiently be improved in some cases, while if it is larger than the above-mentioned range, compatibility with the (meth)acrylate compound becomes worse, so that the polymerizable composition itself for forming the structure is turbid (in the state of a liquid), whereby transparency of the resulting structure is lowered or the fluorine series surfactant is liberated on the surface of the structure to contaminate the surroundings in some cases.

3-3. Substances Other than (Meth)Acrylate Compound and Fluorine Series Surfactant Contained in Polymerizable Composition

The structure of the present invention is formed by polymerizing the “polymerizable composition containing the (meth)acrylate compound”. The “polymerizable composition” may contain, other than the (meth)acrylate compound, a polymerization initiator such as a photopolymerization initiator, a thermal polymerization initiator, etc.; a polymerization inhibitor; a capturing agent; a chain transfer agent; a binder polymer; fine particles; an antioxidant; an ultraviolet absorbing agent; a photostabilizer; a defoaming agent; a mold-releasing agent; a lubricant; a leveling agent; silicone oil; modified silicone oil, etc.

These may be used by optionally selecting from those conventionally known. In the components of the polymerizable composition, those which are merely incorporated into inside thereof by polymerization of the (meth)acrylate compound but do not directly participate in the polymerization are also included.

### 3-3-1. Polymerization Initiator

In the polymerizable composition of the present invention, a polymerization initiator, etc., may be preferably contained. When the structure of the present invention is formed by light irradiation, the polymerizable composition which becomes a material of the structure preferably contains a photopolymerization initiator. The photopolymerization initiator is not particularly limited, and there may be mentioned those conventionally known and used in the radical polymerization, for example, an aryl ketone type photopolymerization initiator such as acetophenones, benzophenones, alkylaminobenzophenones, benzyls, benzoins, benzoin ethers, benzyldimethylacetals, benzoylbenzoates, α-acyloxime esters, etc.; a sulfurcontaining type photopolymerization initiator such as sulfides, thioxanthones, etc.; acylphosphine oxides such as acyldiarylphosphine oxide, etc.; and anthraquinones, etc. A photosensitizer may be also used in combination.

When the structure of the present invention is formed by electron beam irradiation, it is not essential that the polymerizable composition which becomes a material of the structure contains a polymerization initiator, but it may contain the same.

When the structure of the present invention is formed by thermal polymerization, a thermal polymerization initiator is preferably contained. The thermal polymerization initiator may be used those conventionally known and used in the radical polymerization and may be mentioned, for example, peroxides, diazo compounds, etc.

A formulation amount of the polymerization initiator such as a photopolymerization initiator, a thermal polymerization initiator, etc., to be used is generally in the range of 0.2 to 10 parts by weight, preferably 0.5 to 7 parts by weight based on 100 parts by weight of the (meth)acrylate compound.

### 3-3-2. Photostabilizer, Antioxidant and Ultraviolet Absorbing Agent

In the polymerizable composition of the present invention, a photostabilizer and/or an antioxidant and/or an ultraviolet absorbing agent is preferably contained.

When the structure of the present invention contains a photostabilizer, an antioxidant or an ultraviolet absorbing agent, breakage of the fine surface structure of the structure due to aging deterioration by heat or light, or lowering in antireflection performance, mechanical strength or mechanical property, etc., of the surface can be suppressed.

The photostabilizer is preferably mentioned a hindered amine type one.

More specifically, there may be mentioned, for example, TINUVIN 123, TINUVIN 144, TINUVIN 292, TINUVIN 765 (all available from BASF SE), etc., and these are particularly preferred in the point of accomplishing the above-mentioned effects.

The antioxidant is preferably mentioned a phenol type antioxidant, a phosphorus type antioxidant, a sulfur type antioxidant, etc., and a phenol type antioxidant is particularly preferred.

More specifically, there may be mentioned, for example, TINUVIN 1035, TINUVIN 1010, TINUVIN 1076, TINUVIN 1330 (all available from BASF SE), etc., and these are particularly preferred in the point of accomplishing the above-mentioned effects.

The ultraviolet absorbing agent is preferably a benzotriazole type ultraviolet absorbing agent, and specifically mentioned, for example, TINUVIN PS, TINUVIN 99-2, TINUVIN 384-2, TINUVIN 400, TINUVIN 213, TINUVIN 571 (all available from BASF SE), etc., and these are particularly preferred in the point of accomplishing the above-mentioned effects.

The photostabilizer, the antioxidant and the ultraviolet absorbing agent each independently can suppress aging deterioration by heat or light, i.e., breakage of the fine surface structure of the structure, or lowering in antireflection performance, mechanical strength or mechanical property, etc., of the surface. By using the photostabilizer and the antioxidant in combination, or by using the photostabilizer, the antioxidant and the ultraviolet absorbing agent in combination, aging deterioration of the structure by heat and/or under ultraviolet rays can be more suppressed so that it is more preferred. A combination of a hindered amine type photostabilizer and a phenol type antioxidant is preferred, and particularly preferably a combination of the above and further a benzotriazole type ultraviolet absorbing agent.

### 4. Contact Angle

It is essential that the structure of the present invention contains polyethylene glycol di(meth)acrylate in the polymerizable composition which becomes a material thereof in an amount of 53% by mass or more based on the whole (meth)acrylate compound, and it is preferred that the surface is made hydrophilic by adding the polyethylene glycol di(meth)acrylate. Here, “hydrophilic” means a property that a contact angle of water at 20° C. (in the present invention, it is sometimes abbreviated simply as “contact angle”) is small.

In the present invention, the contact angle refers to a contact angle of water obtained according to the tangent method by dropping a drop of water on the structure having a regulated fine relief structure at the surface thereof. Measurement of the contact angle was carried out by using a contact angle measurement device, Model OCAH-200 manufactured by Dataphysica Instruments (Filderstadt). In the present invention, it is defined to be measured as mentioned above.

The structure of the present invention is not particularly limited to a material where the surface of which is hydrophilic, but if the surface is hydrophilic, it is surprisingly possible to provide a structure to which properties such as difficulty in adhering a stain or easiness in wiping a stain by wiping with water, etc., (contamination resistance) have been given.

When the structure having a hydrophilic surface further contains a fluorine series surfactant (particularly preferably “a fluorine series surfactant having an alkylene oxide recurring structure and a fluoroalkyl group”), a structure in which properties such as difficulty in adhering a stain or easiness in wiping a stain by wiping with water, etc., (contamination resistance) are further excellent can be obtained.

More specifically, the above-mentioned structure is preferably a structure having a surface in which the contact angle of water at 20° C. is 35° or less. It is more preferably a contact angle of 30° or less, particularly preferably 25° or less, further preferably 18° or less. If the contact angle at the surface of the structure is too large (if it is not hydrophilic), there is a case where difficulty in adhering a stain or easiness in wiping a stain by wiping with water (contamination resistance), etc., of the surface of the structure are not sufficient.

With regard to the general smooth surface, even if the surface is hydrophilic, it cannot be said that it is excellent in contamination resistance, etc. That is, in the usual smooth surface, it cannot be generally considered that a stain becomes difficulty adhered even if it is made hydrophilic.

However, in the surface having the above-mentioned “specific shape having a property of preventing reflection”, when the surface is hydrophilic, contamination resistance of the surface is surprisingly improved. The present invention has been accomplished by finding out the fact that, in the above-mentioned specific fine surface structure, surface physical properties excellent in contamination resistance, etc., can be realized by making the surface hydrophilic.

As a method for making the surface hydrophilic, it can be generally considered to introduce a hydrophilic functional group such as a hydroxyl group, a carboxyl group, etc., but the surface to which hydrophilicity is provided by a polyethylene glycol chain of a polyethylene glycol di(meth)acrylate is specifically excellent in contamination resistance and mechanical strength such as surface scratch resistance, etc. In addition, as mentioned above, the surface to which hydrophilicity is provided by a polyethylene glycol chain is specifically excellent in contamination resistance and mechanical strength such as surface scratch resistance, etc., than the surface to which hydrophilicity is provided by a polypropylene glycol chain.

For adjusting the contact angle, a composition of the polymerizable composition which is a material for forming the structure of the present invention, for example, a kind or a content of the (meth)acrylate compound is adjusted.

In particular, adjustment is carried out by regulating a kind of the polyethylene glycol di(meth)acrylate (a number of recurring of the ethylene glycol, in particular, a number of recurring is 8 to 25 in average is contained), or regulating an amount of the polyethylene glycol di(meth)acrylate based on the whole amount of the (meth)acrylate compound within the range of 53% by mass or more.

### 5. Storage Elastic Modulus (Storage Elastic Modulus at 25° C. and 180° C.)

The storage elastic modulus at 25° C. of the structure of the present invention (in the present invention, it is sometimes abbreviated simply as “storage elastic modulus”) is not particularly limited, and preferably 2 GPa or less, more preferably 0.05 to 2 GPa, particularly preferably 0.08 to 1.8 GPa, further preferably 0.1 to 1.5 GPa, and most preferably 0.2 to 1.3 GPa.

Also, the storage elastic modulus at 180° C. of the structure of the present invention (in the present invention, it is sometimes abbreviated simply as “storage elastic modulus at 180° C.”) is not particularly limited, and preferably less than 0.5 GPa, more preferably 0.05 to 0.48 GPa, particularly preferably 0.1 to 0.46 GPa, and further preferably 0.15 to 0.45 GPa.

The storage elastic modulus is a physical property not depending on a shape or a size of the material to be measured, but in the present invention, it is measured by a test piece cut out from the structure with a size of about 5 mm×about 40 mm×about 100 μm (thickness), or measured by a test piece separately polymerized to be the above size. As a measurement device, Dynamic viscoelasticity tester DMS6100 manufactured by Seiko Instrument Inc., is used, and a test piece having the above-mentioned shape is sandwiched to the direction of 20 mm and scanned in the range of −20° C. to 200° C. to measure the storage elastic modulus at 25° C. and 180° C. If it has a frequency dependency, the storage elastic modulus measured at 10 Hz is employed.

If the “storage elastic modulus” or “storage elastic modulus at 180° C.” is too low or too high, mechanical strength at the used temperature (for example, at room temperature) is inferior, and the surface of the structure becomes easily worn or easily damaged in some cases.

If the storage elastic modulus or the “storage elastic modulus at 180° C.” is too high, the structure becomes hard and easily brittle, so that in the structure having a specific fine surface structure of the present invention, it can be considered that the surface of the structure is easily abraded or the surface is easily damaged.

When the storage elastic modulus or the “storage elastic modulus at 180° C.” is within the suitable range, it can be considered to prevent from abrasion of the surface of the structure or easily damaging the surface by flexibly escaping an external force such as friction, etc., even if it is a fine structure.

Also, if the storage elastic modulus or the “storage elastic modulus at 180° C.” is too low, the structure becomes too soft, and a mechanical strength to the external force such as friction, etc., is too low so that it can be considered that the surface of the structure is easily abraded or the surface is easily damaged.

For adjusting the storage elastic modulus, and if necessary, for obtaining a sufficient reaction rate or curability, a composition of the polymerizable composition which is a material for forming the structure of the present invention (for example, a kind or a content of the (meth)acrylate compound, a kind or a content of the polymerization initiator, etc.), irradiation conditions of light or electron beam to be used for polymerization (intensity, irradiation time, wavelength, removal of oxygen, etc.), and heating conditions for the polymerization (temperature, heating time, removal of oxygen, etc.), etc., are adjusted.

In particular, in addition to set an amount of the polyethylene glycol di(meth)acrylate within the range of 53% by mass or more based on the whole amount of the (meth)acrylate compound, when a number of recurring of the ethylene glycol chain of the polyethylene glycol di(meth)acrylate being 8 to 25 in average is selected, or an urethane (meth)acrylate is used in combination, it gives a synergistic effect for adjusting the storage elastic modulus to a suitable range.

The structure of the present invention has a specific surface structure which can exhibits low reflectance or high transmittance, so that the physical property thereof is also required to have a specific physical property. The present invention has been accomplished by finding out physical properties of the structure excellent in mechanical strength such as surface scratch resistance, etc., and excellent in contamination resistance, in the specific fine surface structure mentioned above.

When a material for forming an antireflection member which comprises a polymerizable composition for forming the above-mentioned structure having a storage elastic modulus at 25° C. of 2 GPa or less and/or a storage elastic modulus at 180° C. of less than 0.5 GPa, wherein the polymerizable composition contains a (meth)acrylate compound, and the (meth)acrylate compound contains 53% by mass or more of a polyethylene glycol di(meth)acrylate based on the whole (meth)acrylate compound is used, a structure having excellent surface scratch resistance, contamination resistance and mold releasability can be obtained as mentioned above.

Also, when the above-mentioned material for forming an antireflection member in which the above-mentioned polymerizable composition further contains a fluorine series surfactant is used, a structure which is further excellent in surface scratch resistance or contamination resistance can be obtained as mentioned above.

That is, when the material for forming an antireflection member containing the polymerizable composition for forming the above-mentioned structure which contains a (meth)acrylate compound and a fluorine series surfactant is used, a structure which is extremely excellent in surface scratch resistance or contamination resistance can be obtained as mentioned above.

### 6. Method for Producing the Structure

A method for producing the structure of the present invention is not particularly limited, and for example, the following method is preferred. That is, the above-mentioned polymerizable composition is picked on a substrate, and applied thereon by using a coating machine such as a bar coater or an applicator, or a spacer. When the structure is in a film state, it is coated so that the thickness becomes uniform. Here, the “substrate” is not specifically limited, and a film such as polyethylene terephthalate (hereinafter abbreviated to as “PET”), triacetyl cellulose, etc., is suitable. Then, a mold having the above-mentioned surface structure is laminated thereon. After the lamination, the film is polymerized by irradiating ultraviolet ray or irradiating electron beam and/or heating from the film surface. Thereafter, the material in which the polymerizable composition has been polymerized is peeled off from the mold to produce the structure of the present invention.

Or else, the following method is preferred. That is, the polymerizable composition is directly picked on a mold having the above-mentioned surface structure. When the structure is a film state, a coating film with a uniform film thickness may be formed by a coating machine or a spacer. The material in which the polymerizable composition has been polymerized is peeled off from the mold to produce the structure of the present invention.

Also, a particularly preferred method for producing the structure is as follows. That is, it is a method for producing the above-mentioned structure, which comprises supplying a polymerizable composition to a mold having concave parts with an average height of 100 nm or more and 1000 nm or less or convex parts with an average depth of 100 nm or more and 1000 nm or less at the surface thereof, wherein the convex parts or the concave parts thereof are present at an average cycle 50 nm or more and 400 nm or less in at least a certain direction, contact bonding a substrate from thereon, curing the polymerizable composition, and peeling the structure from the mold.

It is also a method for producing a structure, which comprises supplying a polymerizable composition containing a (meth)acrylate compound to a mold having concave parts with an average height of 100 nm or more and 1000 nm or less or convex parts with an average depth of 100 nm or more and 1000 nm or less at the surface thereof, wherein the convex parts or the concave parts thereof are present at an average cycle 50 nm or more and 400 nm or less in at least a certain direction, curing the polymerizable composition by light irradiation, electron beam irradiation and/or heating, and peeling the structure from the mold, wherein the (meth)acrylate compound contains 53% by mass or more of a polyethylene glycol di(meth)acrylate based on the whole (meth)acrylate compound.

Also, a more preferred method for producing a structure is a method for producing the above-mentioned structure, wherein the above-mentioned polymerizable composition further contains a fluorine series surfactant, and a particularly preferred method for producing a structure is a method for producing the above-mentioned structure, wherein the above-mentioned polymerizable composition further contains “a fluorine series surfactant having an alkylene oxide recurring structure and a fluoroalkyl group”.

The mold is not specifically limited, and as an example, there may be mentioned a material in which the above-mentioned shape is formed on the surface of aluminum (alloy) by repeating “anodization” and “etching of the anodization film obtained thereby” of aluminum or aluminum alloy as preferred ones. It can be preferably produced according to the method disclosed in the above-mentioned Patent Document 14 or Patent Document 15.

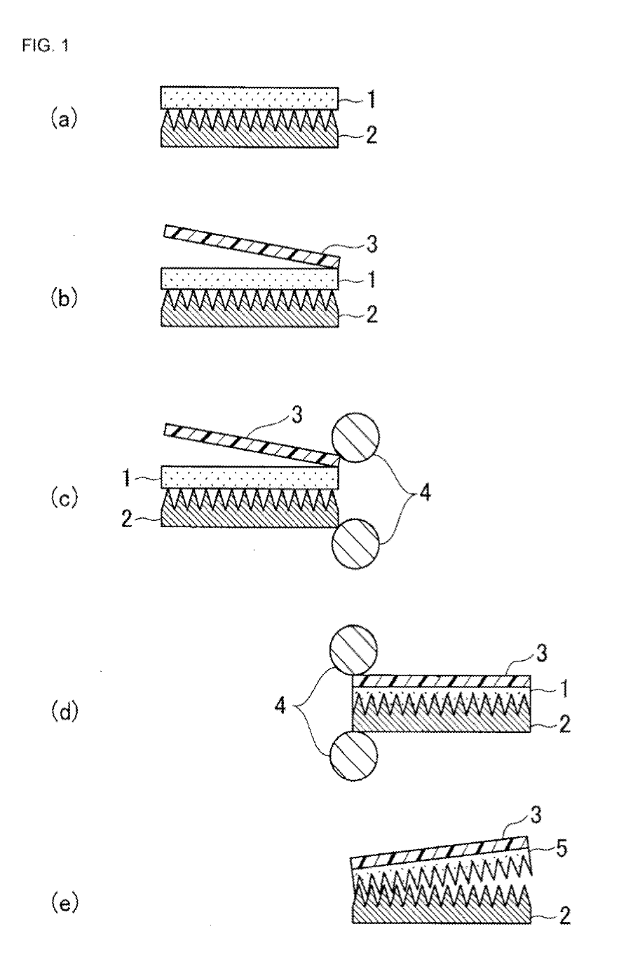

The method for producing the structure of the present invention is further specifically explained by using FIG. 1, but the present invention is not limited to the specific embodiment of FIG. 1. That is, an appropriate amount of the polymerizable composition (1) is supplied or applied to the mold (2) (FIG. 1(a)), and the substrate (3) is adhered thereto from an oblique direction with a roller portion side as a supporting point (FIG. 1(b)). A laminated material in which the mold (2), the polymerizable composition (1) and the substrate (3) are integrated is moved to a roller (4) (FIG. 1(c)), and subjected to pressure bonding by the roller to transfer and shape the specific structure possessed by the mold (2) onto the polymerizable composition (1) (FIG. 1(d)). After curing the material, it is peeled off from the mold (2) (FIG. 1(e)), to obtain the structure (5) to be objected by the present invention.

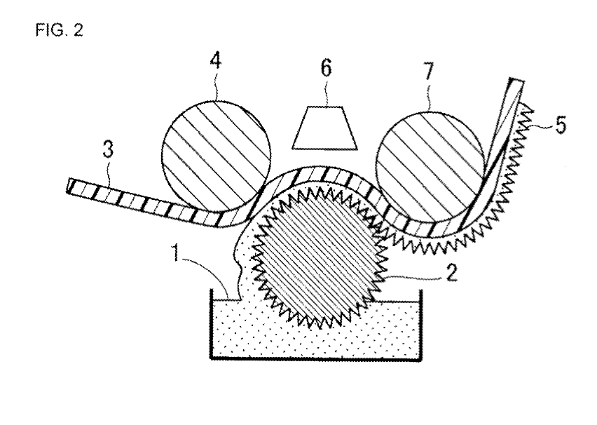

FIG. 2 is a schematic view showing an example of a device for producing the structure continuously, and the present invention is not limited to the schematic view. That is, the polymerizable composition (1) is attached to the mold (2), a force is given by the roller (4), and the substrate (3) is laminated to the mold from an oblique direction to transfer the specific structure possessed by the mold (2) onto the polymerizable composition (1). This is cured by using a curing device (6), and then, peeled off from the mold (2) to obtain the structure (5) to be objected by the present invention. A supporting roller (7) is to lift the structure (5) upward.

The material is laminated from an oblique direction by using the roller (4), the structure (5) having no defect without bubble can be obtained. Also, when the roller is used, a linear pressure is given, and thus, the pressure can be enlarged so that it is possible to produce a structure having a large surface area and control of the pressure becomes easy. Also, when the structure (5) is a film state, it is possible to produce a structure having a uniform film thickness which is integrated with the substrate and predetermined optical properties, and further it becomes excellent in productivity since it can be produced continuously.

In the structure of the present invention, it is essential to be polymerized by light irradiation, electron beam irradiation and/or heating, and the wavelength of the light in the light irradiation is not particularly limited. It is preferred that the light contains the visible light and/or the ultraviolet ray because the carbon-carbon double bonds of the (meth)acryl groups are polymerized well in the presence of the photopolymerization initiator, if necessary. Particularly preferred is the light containing the ultraviolet ray. A light source is not particularly limited, and those publicly known such as an ultra-high pressure mercury lamp, a high pressure mercury lamp, a halogen lamp, an electrodeless lamp and various lasers can be used. In the case of the electron beam irradiation, the intensity and the wavelength of the electron beam are not particularly limited, and publicly known methods can be used.

When the polymerization is carried out by heat, the temperature is not particularly limited, and is preferably 80° C. or higher, particularly preferably 100° C. or higher. Also, it is preferably 200° C. or lower, and particularly preferably 180° C. or lower. If the polymerization temperature is too low, the polymerization does not proceed sufficiently in some cases, while if it is too high, the polymerization becomes ununiform or deterioration of the substrate occurs in some cases. Heating time is not also particularly limited, and is preferably 5 seconds or longer, particularly preferably 10 seconds or longer. Also, it is preferably 10 minutes or shorter, particularly preferably 2 minutes or shorter, further preferably 30 seconds or shorter.

### 7. Action and Principle

In the surface of the structure of the present invention having a specific surface structure, it is not yet clear about the action and the principle why the obtained structure has flexible and excellent mechanical strength, the surface is difficulty damaged, and difficulty in adhering a stain or easiness in wiping a stain by wiping with water (contamination resistance), etc., is excellent if 53% by mass or more of a polyethylene glycol di(meth)acrylate is contained in the polymerizable composition based on the whole (meth)acrylate compound. Also, whereas the present invention is not limited to the range which can be applicable to the following action and principle, as for improvement in mechanical strength, it can be considered by the reasons that the moderate intermolecular distance of the functional groups of the polyethylene glycol di(meth)acrylate and the molecular structure of the ethylene glycol chain are interacted to form a surface of the structure having a mechanical property which flexibly resist to an external force applied to each concave and convex fine structure of the surface.

With regard to difficulty in adhering a stain or easiness in wiping a stain by wiping with water, in particular, a wiping property of a stain by wiping with water, it can be considered that the fine surface structure is hydrophilic, so that the attached stain (oil) is wiped with water, the water is wet and spread to the concave parts of the hydrophilic surface to form a water layer at the interface of the stain component and the structure, whereby the stain component seems to be easily wiped away when it is wiped.

In addition, it can be considered that the quality of the film is flexible would contribute to improve easiness in wiping a stain by wiping with water. That is, by moving the fine structure flexible, it can be considered that it helps to incorporate water into the concave parts, or to go out the stain outside the concave parts, as a result, easiness in wiping a stain by wiping with water seems to be improved.

To the contrary, if it is not hydrophilic, it can be considered that even when the attached stain (oil) is wiped with water, the water is difficulty wet and spread to the concave parts of the surface, in particular, a stain component incorporated into the concave parts seems to be difficulty wiped away.

Also, it is not yet clear about the action and the principle why the obtained structure has moderate flexibility and particularly excellent mechanical strength, in particular, the surface is difficulty damaged, and contamination resistance is excellent if the structure of the present invention having a specific surface structure has the above-mentioned storage elastic modulus. Whereas the present invention is not limited to the range which can be applicable to the following action and principle, it can be considered by the reason that, when taking the mechanical property of the polymer into account, the surface of the structure obtains a performance that can endure an external force if the mechanical property of each concave and convex fine portion takes a value within a specific value. In particular, it can be considered that each concave and convex becomes flexible, so that a stress is applied thereto, they do not folded, and accordingly, damages can be prevented whereby mechanical strength such as surface scratch resistance, etc., or properties such as easiness in wiping off a stain, etc., can be provided to the surface of the structure.

In the surface of the structure of the present invention having a specific surface structure, it is not yet clear about the action and the principle why the obtained structure has flexible and excellent mechanical strength, the surface is difficulty damaged, and difficulty in adhering a stain or easiness in wiping a stain by wiping with water (contamination resistance), etc., is excellent if the polymerizable composition further contains the fluorine series surfactant, and the present invention is not limited to the range which can be applicable to the following action and principle. The structure having a specific surface structure has flexibility and mechanical strength, and the fluorine series surfactant acts on the surface as a lubricant to further improve the property that the surface is difficulty damaged. Further, the structure of the fluorine series surfactant possesses an alkylene oxide recurring structure and a fluoroalkyl group so that it can be considered that affinity with water becomes good, and due to the synergistic effect with the structure having a specific surface structure which possesses hydrophilic property, it seems to be further extremely excellent in difficulty in adhering a stain or easiness in wiping a stain by wiping with water (contamination resistance), etc.

### EXAMPLES

In the following, the present invention is explained in more detail by referring to Examples, but the present invention is not limited by these so long as it does not exceed the gist thereof.

### Example 1

### [Production of Structure]

70 g of a material in which m=24 (m represents a number of recurring units of the ethylene glycol) in the “polyethylene glycol diacrylate represented by the following formula (2)” included in the above-mentioned formula (1), 30 g of an urethane (meth)acrylate (a) in which two dipentaerythritol pentaacrylates are bonded to isophorone diisocyanate represented by the following formula (a), and 5 g of 1-hydroxycyclohexylphenyl ketone as a photopolymerization initiator were mixed under stirring to obtain a polymerizable composition.

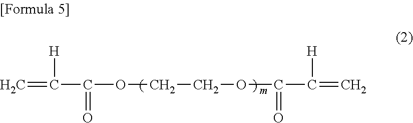

[in the formula (2), m represents a natural number.]

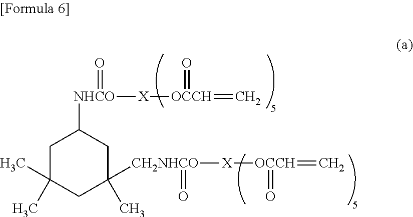

[in the formula (a), X represents a residue of dipentaerythritol (having 6 hydroxyl groups).]

Then, an appropriate amount of the composition was picked onto a PET film, and was applied so that it became a uniform film thickness by a bar coater NO28. Thereafter, a mold having a structure in which convex parts having an average height of 150 nm had been arranged with an average cycle of 205 nm on the surface thereof was laminated thereto. Confirming that the entire mold was laminated to the polymerizable composition, the composition was polymerized by irradiating ultraviolet ray at 800 mJ/cm² using an UV irradiation device manufactured by Fusion Inc., to produce the structure.

### [Evaluation]

The obtained structures were evaluated by the following methods. The results are shown in Table 1.

### <Evaluation Method and Judgment Criteria of Surface Scratch Resistance>

Steel wool #0000 was uniformly attached on a smooth cross section of a 25 mm cylinder which has been mounted on a surface test machine, Tribogear TYPE-14DR manufactured by Shinto Scientific Co., Ltd., and the cylinder was reciprocated ten round trips on the surface of the respective structures at a speed of 10 cm/second under a load of 400 g. Then, the state of the scratches attached onto the surface of the structure was observed. The levels were judged by the following criteria, and 4 or more are judged as good, 3 is judged as slightly good and 2 or less are judged as bad.

### (Judgment Criteria)

5: Less than several scratches
4: Several to ten scratches
3: A half of the 25 mm cylinder was scratched
2: Two thirds of the 25 mm cylinder was scratched
1: Whole surface of the 25 mm cylinder was scratched

### <Measurement Method of Reflectance>

Using a self-recording spectrophotometer “UV-3150” supplied from Shimadzu Corporation, a black tape was attached on the backside, and a 5° incident absolute reflectance at the surface of the structure was measured. The measurement wavelength was made from 380 nm to 780 nm.

### <Evaluation Method and Judgment Criteria of Contamination Resistance>

Oil of a forefinger was attached on the surface of the structure by strongly pressing, to clearly identify the fingerprint stain by observing with eyes from the front.

Thereafter, one sheet of commercially available tissue paper was folded to 3 cm square, water was sufficiently soaked thereinto (with the extent that water drops do not fall), and the wet paper was taken, the surface of the structure was wiped with water at 5 round trips so as to wipe off the above-mentioned fingerprint stain with a strength like a weight of the arm. Then, excessive moisture remained at the wiped portion was wiped away once with a dry tissue paper.

Thereafter, by using the above-mentioned measurement method of the reflectance, reflectance (%) of the surface of the structure after wiping with water was measured, and it was compared with the reflectance (%) of the surface of the structure before wiping with water.

Judgment was carried out by the following criteria, and increase in the reflectance of 0.2 point or less (⊚, ∘) was judged as “good”, that of larger than 0.2 point and 0.3 point or less (Δ) was judged as “slightly good”, and that of exceeding 0.3 point (x) was judged as “bad”.

An increased part (%) of the reflectance (%) is made a “point”. That is, for example, if the reflectance (%) of the surface of the structure before wiping with water is 0.2%, and the reflectance (%) of the surface of the structure after wiping with water is 0.3%, then, the increase of the reflectance (%) is “0.1 point”.

Incidentally, an increased value of the reflectance and the state at which the fingerprint stain was observed with eyes are roughly as follows.

### (Judgment Criteria)

[Increased Value of Reflectance and the State at which Fingerprint Stain was Observed with Eyes]
⊚: 0.1 point or less. Fingerprint stain cannot be observed from the front or from the oblique direction.
∘: Larger than 0.1 point and 0.2 point or less. Fingerprint stain cannot be observed from the front but slightly observed from the oblique direction.
Δ: Larger than 0.2 point and 0.3 point or less. Fingerprint stain cannot be observed from the front but observed from the oblique direction.
x: Larger than 0.3 point and 0.5 point or less, fingerprint stain can be observed from the front.

### <Contact Angle>

The “contact angle” refers to a contact angle of water obtained according to the tangent method by dropping water on the structure having a regulated fine relief structure at the surface thereof. Measurement of the contact angle was carried out by using a contact angle measurement device, Model OCAH-200 manufactured by Dataphysica Instruments (Filderstadt).

### <Storage Elastic Modulus>

The structures obtained as mentioned above were each cut into 5 mm×40 mm to prepare a test piece of 5 mm×40 mm×100 μm. The measurement was carried out by using Dynamic viscoelasticity tester DMS6100 manufactured by Seiko Instrument Inc., and a test piece having the above-mentioned shape is sandwiched to the direction of 20 mm and a force of 10 Hz, and scanned in the range of −20° C. to 200° C. to measure the storage elastic modulus at 25° C. to make it “storage elastic modulus”.

### <180° C. Storage Elastic Modulus>

In the same manner as in the above-mentioned measurement method of the storage elastic modulus at 25° C., scanning was carried out in the range of −20° C. to 200° C. to measure the storage elastic modulus at 180° C. to make it “180° C. storage elastic modulus”.

### Examples 2 to 7 and Comparative Examples 1 to 11

An appropriate amount of the polymerizable composition having the composition shown in Table 1 was picked onto a PET film, and was applied so that it became a uniform film thickness in the same manner as in Example 1. Thereafter, the similar mold as in Example 1 was laminated thereto, the composition was polymerized in the same manner to produce the respective structures. Incidentally, the unit of the numerals in Table 1 is [g].

In Example 1, Example 2 and Comparative Example 1, in the polyethylene glycol diacrylate represented by the above-mentioned formula (2), a material of m=24 (m represents a number of average recurring units of ethylene glycol) was used in an amount shown in Table 1.

Also, in Example 3, Example 4, Example 7, Comparative Example 2, Comparative Example 4 and Comparative Example 11, in the polyethylene glycol diacrylate represented by the above-mentioned formula (2), a material of m=14 (m represents a number of average recurring units of ethylene glycol) was used in an amount (the numerals in Table 1 show [g]) shown in Table 1.

Also, in Example 5, Example 6 and Comparative Example 3, in the polyethylene glycol diacrylate represented by the above-mentioned formula (2), a material of m=9 (m represents a number of average recurring units of ethylene glycol) was used in an amount (the numerals in Table 1 show [g]) shown in Table 1.

In Table 1, in the propylene glycol diacrylate, m also represents a number of an average recurring unit of the propylene glycol.

In Table 1, the urethane (meth)acrylate (b) represents a material in which three pentaerythritol triacrylates are bonded to a nurate material (tri-functional isocyanate) where hexamethylene diisocyanates are trimerized to form a 6-membered ring.

TABLE 1

| | No. | | | | | | | | | | |
|---|---|---|---|---|---|---|---|---|---|---|---|
| | Number of | | | Compar- | | | Compar- | | | Compar- | |
| Components of | recurring | Exam- | Exam- | ative | Exam- | Exam- | ative | Exam- | Exam- | ative | Exam- |
| polymerizable composition | units | ple 1 | ple 2 | Example 1 | ple 3 | ple 4 | Example 2 | ple 5 | ple 6 | Example 3 | ple 7 |
| Polyethylene glycol diacrylate | m = 24 | 70 | 53 | 30 | | | | | | | |
| represented by the formula (2) | m = 14 | | | | 70 | 53 | 30 | | | | 70 |
| | m = 9 | | | | | | | 70 | 53 | 30 | |
| Polypropylene glycol diacrylate | m = 9 | | | | | | | | | | |

| | | | | | | | | | | |
|---|---|---|---|---|---|---|---|---|---|---|
| Decanediol diacrylate | | | | | | | | | | |
| Bisphenol A type epoxyacrylate | | | | | | | | | | |
| Urethane (meth)acrylate (a) | 30 | 47 | 70 | 30 | 47 | 70 | 30 | 47 | 70 | |
| Urethane (meth)acrylate (b) | | | | | | | | | | 30 |
| Photopolymerization initiator | 5 | 5 | 5 | 5 | 5 | 5 | 5 | 5 | 5 | 5 |
| 1-hydroxycyclohexyl phenyl ketone | | | | | | | | | | |
| Surface scratch resistance | 5 | 4 | 2 | 5 | 4 | 2 | 4-5 | 4 | 1 | 5 |
| Reflectance (%) before wiping with water | 0.2 | 0.2 | 0.2 | 0.2 | 0.2 | 0.2 | 0.2 | 0.2 | 0.2 | 0.2 |
| Contamination resistance | 0.2 | 0.3 | 0.6 | 0.2 | 0.4 | 0.8 | 0.3 | 0.5 | 0.8 | 0.2 |
| Reflectance (%) after wiping with water | | | | | | | | | | |
| Judgment | ⊚ | ⊚ | X | ⊚ | ◯ | X | ⊚ | Δ | X | ⊚ |
| Contact angle [deg] | 18 | 18 | 60 | 18 | 35 | 60 | 25 | 35 | 60 | 18 |
| 25° C. Storage elastic modulus [GPa] 25° C. | | | | 0.48 | 1.12 | 3.03 | | | | 0.28 |
| 180 C. Storage elastic modulus [GPa] 180° C. | | | | 0.24 | 0.48 | 0.93 | | | | 0.15 |

| | No. | | | | | | | | |
|---|---|---|---|---|---|---|---|---|---|
| | Number of | Compar- | Compar- | Compar- | Compar- | Compar- | Compar- | Compar- | Compar- |
| Components of | recurring | ative | ative | ative | ative | ative | ative | ative | ative |
| polymerizable composition | units | Example 4 | Example 5 | Example 6 | Example 7 | Example 8 | Example 9 | Example 10 | Example 11 |
| Polyethylene glycol diacrylate | m = 24 | | | | | | | | |
| represented by the formula (2) | m = 14 | 30 | | | | | | | 48 |
| | m = 9 | | | | | | | | |
| Polypropylene glycol diacrylate | m = 9 | | 70 | 53 | 30 | | | | |

| | | | | | | | | |
|---|---|---|---|---|---|---|---|---|
| Decanediol diacrylate | | | | | 70 | 53 | 30 | |
| Bisphenol A type epoxyacrylate | | | | | | | | 5 |
| Urethane (meth)acrylate (a) | | 30 | 47 | 70 | 30 | 47 | 70 | 47 |
| Urethane (meth)acrylate (b) | 70 | | | | | | | |
| Photopolymerization initiator | 5 | 5 | 5 | 5 | 5 | 5 | 5 | 5 |
| 1-hydroxycyclohexyl phenyl ketone | | | | | | | | |
| Surface scratch resistance | 2 | 3 | 2 | 1 | 3 | 1 | 1 | 3-4 |
| Reflectance (%) before wiping with water | 0.2 | 0.2 | 0.2 | 0.2 | 0.2 | 0.2 | 0.2 | 0.2 |
| Contamination resistance | 0.6 | 0.8 | 0.8 | 0.8 | 0.8 | 0.8 | 0.8 | 0.8 |
| Reflectance (%) after wiping with water | | | | | | | | |
| Judgment | X | X | X | X | X | X | X | X |
| Contact angle [deg] | 40 | 60 | 60 | 60 | 60 | 60 | 60 | — |
| 25° C. Storage elastic modulus [GPa] 25° C. | 3.12 | | | | | | | 2.20 |
| 180 C. Storage elastic modulus [GPa] 180° C. | 0.70 | | | | | | | 1.00 |

Examples 1 to 7 which contain 53% by mass or more of the polyethylene glycol di(meth)acrylate based on the whole (meth)acrylate compound showed the surface scratch resistance of all 4 or more, and the contamination resistance was all “Δ” or more (that is, an increased value of reflectance after wiping with water is 0.3 point or less), and were all totally extremely excellent.

On the other hand, Comparative Examples 1 to 4 and 11 which contain polyethylene glycol di(meth)acrylate but with an amount of less than 53% by mass based on the whole (meth)acrylate compound showed the surface scratch resistance of all less than 4, and the contamination resistance of “x” (that is, an increased value of the reflectance after wiping with water of larger than 0.3 point).

Also, Comparative Examples 5 to 10 which do not contain polyethylene glycol di(meth)acrylate showed the surface scratch resistance of all 3 or less, and the contamination resistance of “x” (that is, an increased value of the reflectance after wiping with water of larger than 0.3 point) (they were all actually increased 0.6 point).

Comparative Examples were inferior in all the performances which had been evaluated, and were totally inferior to those of the invention. In particular, Comparative Examples 5 to 7 in which the polypropylene glycol di(meth)acrylate was used in place of the polyethylene glycol di(meth)acrylate were also totally inferior to those of the invention.

Also, from Examples 1 to 7, it can be understood that particularly excellent performances could be obtained when the polyethylene glycol di(meth)acrylate and the urethane (meth)acrylate were used in combination.

With regard to the contact angle, Examples 1 to 7 were all 35° or less, but Comparative Examples were all 40° or more. Actually, other than Comparative Example 4 of 40°, they were all extremely large as 60°. According to the above, it can be understood that particularly excellent surface scratch resistance and contamination resistance could be accomplished in the structure having a small contact angle, i.e., having a hydrophilic surface.

With regard to the storage elastic modulus at 25° C., it was all 2 GPa or less in the measured Examples, but in the measured Comparative Examples, it was all larger than 2 GPa. According to the above, it can be understood that particularly excellent surface scratch resistance and contamination resistance could be accomplished if the storage elastic modulus at 25° C. is smaller than a certain value.

In addition, with regard to “180° C. storage elastic modulus”, it was all less than 0.5 GPa in the measured Examples, but in the measured Comparative Examples, it was all 0.7 GPa or more.

The structures produced in Examples and Comparative Examples shown in the above-mentioned Table 1 were all good and excellent in the antireflection performance of the light and the improved performance of light permeability.

### Examples 8 and 9

As shown in Table 2, in the polyethylene glycol diacrylate represented by the formula (2), a number of recurring units m was fixed to 14, and the ratio with the urethane (meth)acrylate (a) was changed to the one where the amount of the polyethylene glycol diacrylate were increased, and the structures were evaluated. The polymerizable composition and the method for producing the structure were the same as in Example 1. The amount shown in Table 2 is [parts by mass]. The results are also shown in Table 2.

In addition, with regard to Example 3, Example 4 and Comparative Example 2 in Table 1, they were also shown in Table 2 for reference.

TABLE 2

| | No. | | | | |
|---|---|---|---|---|---|
| | | | | | Comparative |
| | Example 8 | Example 9 | Example 3 | Example 4 | Example 2 |
| In polyethylene glycol diacrylate represented by | 90 | 80 | 70 | 53 | 30 |
| the formula (2), m = 14 | | | | | |
| Urethane (meth)acrylate (a) | 10 | 20 | 30 | 47 | 70 |
| Photopolymerization initiator | 5 | 5 | 5 | 5 | 5 |
| 1-Hydroxy-cyclohexyl phenyl ketone | | | | | |
| Surface scratch resistance | 3 | 4 | 5 | 4 | 2 |
| Reflectance (%) before wiping with water | 0.2 | 0.2 | 0.2 | 0.2 | 0.2 |
| Contamination resistance | | | | | |
| Reflectance (%) after wiping with water | 0.2 | 0.2 | 0.2 | 0.4 | 0.8 |
| Judgment | ⊚ | ⊚ | ⊚ | ◯ | X |
| Contact angle [deg] | 18 | 18 | 18 | 35 | 60 |
| Storage elastic modulus [GPa] 25° C. | 0.08 | 0.21 | 0.48 | 1.12 | 3.03 |
| 180° C. Storage elastic modulus [GPa] 180° C. | 0.11 | 0.20 | 0.24 | 0.48 | 0.93 |

From Table 2, in Examples 8, 9, 3 and 4 where the polyethylene glycol di(meth)acrylate is contained in the whole (meth)acrylate compound with 53% by mass or more, the storage elastic modulus at 25° C. were all 2 GPa or less, and the performances were all totally excellent. However, in Comparative Example 2 where the content of the polyethylene glycol di(meth)acrylate is a little, it was large as 3.03 GPa, and the performances were not so excellent.

Also, 180° C. storage elastic modulus of Examples 8, 9, 3 and 4 were all less than 0.5 GPa (actually 0.48 GPa or less).

The structures prepared in Examples and Comparative Example shown in the above-mentioned Table 2 were all good and excellent with regard to antireflection performance of the light and improved performance of light permeability.

### Reference Examples 1 and 2

The polymerizable composition was made the same, and the difference in the surface structure was investigated. That is, by using the respective polymerizable compositions of Example 3 and Comparative Example 2, in place of the structure having a specific fine surface structure, a structure having a flat surface (a structure in which the mold is not transferred by laminating the mold) was used and evaluated.

In Table 3, components of the polymerizable compositions of Reference Example 1 (the same polymerizable composition as in Example 3 was used) and Reference Example 2 (the same polymerizable composition as in Comparative Example 2 was used) and evaluation results are shown.

In Table 3, the “contamination resistance (judged by naked eyes)” was judged according to the judgment criteria of the “state when the fingerprint stain was observed with naked eyes” in the above-mentioned <Evaluation method and judgment criteria of contamination resistance>.

TABLE 3

| | | No. | | | |
|---|---|---|---|---|---|
| | | | Comparative | Reference | Reference |
| | | Example 3 | Example 2 | Example 1 | Example 2 |
| Surface of the structure | | Fine structure | Fine structure | No fine | No fine |
| | | exists | exists | structure | structure |
| Component of polymerizable composition | | | | | |
| Polyethylene glycol diacrylate | Number of | 70 | 30 | 70 | 30 |
| represented by the formula (2) | recurring unit m = 14 | | | | |

| | | | | |
|---|---|---|---|---|
| Urethane (meth)acrylate (a) | 30 | 70 | 30 | 70 |
| Photopolymerization initiator | 5 | 5 | 5 | 5 |
| 1-Hydroxycyclohexyl phenyl ketone | | | | |
| Surface scratch resistance | 5 | 2 | 5 | 5 |
| Contamination resistance (judged by naked eyes) | ⊚ | X | ⊚ | ⊚ |
| Contact angle [deg] | 18 | 60 | 55 | 65 |

With regard to the contact angle, it was 18° on the surface of the fine structure of the present invention so that it was hydrophilic (Example 3), but at the flat surface, it was 55° so that it was not hydrophilic (Reference Example 1). That is, only when a specific material has a specific surface structure, the surface firstly became hydrophilic.

With regard to the contamination resistance, the polymerizable composition of Comparative Example 2 was “x” when it was the surface of the fine structure of the present invention (Comparative Example 2), but it became “⊚” when it was the flat surface (Reference Example 2). It could be understood that the contamination resistance was lowered by the reason that the surface had the specific surface structure. To the contrary, in Reference Example 2 with the flat surface, the contamination resistance was kept to be good.

In the polymerizable composition of Comparative Example 2, whereas the surface scratch resistance was bad when it was the surface of the fine structure of the present invention, it was good when it was the flat surface (Reference Example 2). It could be clarified that the surface scratch resistance was tend to be lowered by the reason that the surface had the specific surface structure.

Also, it can be understood when the storage elastic modulus took a specific value, a structure excellent in surface scratch resistance could be obtained.

That is, in the flat surface, even when it was a surface of the “structure obtained by polymerizing the polymerizable composition containing the (meth)acrylate compound which contains 53% by mass or more of the polyethylene glycol di(meth)acrylate based on the whole (meth)acrylate compound”, the contact angle was 55° so that it did not became hydrophilic, but the contamination resistance was “⊚”, and the surface scratch resistance was “5” (Reference Example 1).

Accordingly, as far as the surface of the fine structure of the present invention is concerned, on the surface of the “structure obtained by polymerizing the polymerizable composition containing the (meth)acrylate compound which contains 53% by mass or more of the polyethylene glycol di(meth)acrylate based on the whole (meth)acrylate compound”, the contact angle became 18° and the surface became hydrophilic, whereby the contamination resistance became “⊚” (Example 1) accompanied thereby.

According to the above, it could be understood that the physical properties at the flat surface and evaluation results, etc., are not a reference on the surface of the fine structure of the present invention at all.

### Example 10

### Manufacture of Structure

### <Manufacture of Structures Nos. 1, 2 and 3>

In the “polyethylene glycol diacrylate represented by the following formula (2)” included in the above-mentioned formula (1), a material where m=14 was contained in an amount of 70 parts by mass in the structure No. 1, 53 parts by mass in the structure No. 2, and 61 parts by mass in the structure No. 3.

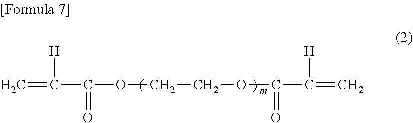

[in the formula (2), m represents a number of an average recurring unit.]

Further, the urethane (meth)acrylate (a) in which two dipentaerythritol pentaacrylates had been bonded to the isophorone diisocyanate represented by the following formula (a) was contained in an amount of 30 parts by mass in the structure No. 1, 47 parts by mass in the structure No. 2, and 36 parts by mass in the structure No. 3.

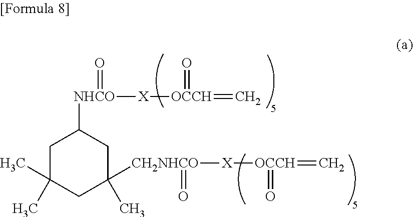

[in the formula (a), X represents a residue of dipentaerythritol (having 6 hydroxyl groups).]

Also, in the structure No. 3, 3 parts by mass of the urethane (meth)acrylate (b) represented by the following was further contained.

2HEA-IPDI-(polyester of adipic acid and 1,6-hexanediol with a weight average molecular weight of 3500 having both ends of hydroxyl groups)-IPDI-2HEA

In the above-mentioned formula, “2HEA” represents 2-hydroxyethylacrylate, “IPDI” represents isophorone diisocyanate, “-” represents a bond by the usual reaction of the isocyanate group and the hydroxyl group mentioned below.

—NCO+HO—→—NHCOO—

Further, in each of the structures Nos. 1, 2 and 3, 0.5 part by mass of “the fluorine series surfactant (a) belonging to the fluorine series surfactant represented by the above-mentioned formula (F)” shown below was contained.

The fluorine series surfactant (a) is a material where R¹ is F, R² is H, R³ is H, X is “—CH₂CH₂O—”, p=8 and q=10 in the following formula (F).

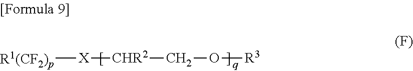

[in the formula (F), R¹ represents H or F, R² represents H or CH₃, R³ represents H or CH₃, X represents a divalent linking group, p is an integer of 2 or more and 18 or less, and q is an integer of 4 or more and 20 or less.]

Moreover, in each of the structures Nos. 1, 2 and 3, 5 parts by mass of 1-hydroxycyclohexylphenyl ketone was contained as a photopolymerization initiator.

With regard to the structures Nos. 1, 2 and 3, the respective components mentioned above were mixed under stirring until they became uniform to obtain the respective polymerizable compositions. The components and compositions were summarized in Table 4. Incidentally, the unit of the numerals in Table 4 was “parts by mass”.

Then, an appropriate amount of the composition was picked onto a PET film, and was applied so that it became a uniform film thickness by a bar coater NO28. Thereafter, a mold having a structure in which convex parts having an average height of 150 nm had been arranged with an average cycle of 205 nm on the surface thereof was laminated thereto. Confirming that the entire mold was laminated to the polymerizable composition, the composition was polymerized by irradiating ultraviolet ray at 800 mJ/cm² using an UV irradiation device manufactured by Fusion Inc., to produce the structure.

### <Manufacture of Structures Nos. 4 to 6>

The polymerizable compositions having the composition shown in Table 4 were obtained in the same manner as mentioned above, and an appropriate amount of the composition was picked onto a PET film and was applied so that it became a uniform film thickness in the same manner as in Example 1. Thereafter, a similar mold as in Example 1 was laminated thereto and the composition was polymerized similarly to produce the respective structures. Incidentally, the unit of the numerals in Table 4 was “parts by mass”.

The structure No. 4 was produced in the same manner as in the structure No. 3 except for using the fluorine series surfactant (b) in place of the fluorine series surfactant (a) in the production of the structure No. 3.

The fluorine series surfactant (b) is a material wherein R¹ is F, R² is H, R³ is H, X is “—CH₂CH₂O—”, p=6 and q=5 in the above-mentioned formula (F).

The structure No. 5 was produced in the same manner as in the structure No. 3 except for using the fluorine series surfactant (c) in place of the fluorine series surfactant (a) in the production of the structure No. 3.

The fluorine series surfactant (c) is a material wherein R¹ is F, R² is H, R³ is H, X is “—CH₂CH₂O—”, p=6 and q=10 in the above-mentioned formula (F).

The structure No. 6 was produced in the same manner as in the structure No. 3 except that the content of the fluorine series surfactant (a) was changed from 0.5 part by mass to 3.0 parts by mass in the production of the structure No. 3.

### <Manufacture of Structures Nos. 7 to 9>

The structures Nos. 7 to 9 were produced in the same manner as in the structure No. 3 except for using the fluorine series surfactant (d): FL-100-100st (available from Shin-Etsu Chemical Co., Ltd.) in place of the fluorine series surfactant (a) in the structure No. 7, using the silicon series lubricant A: X-22-164AS (available from Shin-Etsu Chemical Co., Ltd.) in the structure No. 8, and using the silicon series lubricant B: X-24-8201 (available from Shin-Etsu Chemical Co., Ltd.) in the structure No. 9, in the production of the structure No. 3.

The fluorine series surfactant (d) (FL-100-100st (available from Shin-Etsu Chemical Co., Ltd.)) is a fluorine series surfactant with a polydimethylsiloxane structure having a fluoroalkyl group (—CH₂CH₂CF₃) at the side chain.

Also, the silicon series lubricant A (X-22-164AS (available from Shin-Etsu Chemical Co., Ltd.)) is a polydimethylsiloxane in which the both ends were modified by the methacrylic acid, and the silicon series lubricant B (X-24-8201 (available from Shin-Etsu Chemical Co., Ltd.)) is a polydimethylsiloxane in which one end was modified by the methacrylic acid.

### <Manufacture of Structures Nos. 10 to 12>

The structure No. 10 was produced in the same manner as in the structure No. 1 except for containing the fluorine series surfactant.

The structure No. 11 was produced in the same manner as in the structure No. 2 except for containing the fluorine series surfactant.

The structure No. 12 was produced in the same manner as in the structure No. 3 except for containing the fluorine series surfactant.

### [Evaluation]

The obtained structures were evaluated by the following methods. The results are shown in Table 4.

### <Evaluation Method and Judgment Criteria of Surface Scratch Resistance>

Steel wool #0000 was uniformly attached on a smooth cross section of a 25 mm cylinder which has been mounted on a surface test machine, Tribogear TYPE-14DR manufactured by Shinto Scientific Co., Ltd., and the cylinder was reciprocated ten round trips on the surface of the respective structures at a speed of 10 cm/second under a load of 400 g. Then, the state of the scratches attached onto the surface of the structure was observed.

They were judged by the following criteria in which further excellent “6” was added to the judgment criteria “1” to “5” in the above-mentioned Examples 1 to 9, etc., and 6 was made extremely excellent, 4 to 5 good, 3 slightly good, and 2 or less bad.

### (Judgment Criteria)

6: No scratch
5: Less than several scratches
4: Several to ten scratches
3: A half of the 25 mm cylinder was scratched
2: Two thirds of the 25 mm cylinder was scratched
1: Whole surface of the 25 mm cylinder was scratched

### <Measurement Method of Reflectance>

### <Evaluation Method and Judgment Criteria of Contamination Resistance>

The measurement methods of the “reflectance” and the “contamination resistance” are the same as the measurement methods of the above-mentioned Examples 1 to 9, etc.

Thereafter, by using the above-mentioned measurement method of the reflectance, the reflectance (%) of the surface of the structure after wiping with water was measured, and compared with the reflectance (%) of the surface of the structure before wiping with water.

Judgment was carried out by the following criteria, and increase in the reflectance of 0.2 point or less (⋆, ⊚, ◯) was judged as “good” (⋆ was judged as “extremely good”), that of larger than 0.2 point and 0.3 point or less (Δ) was judged as “slightly good”, and that of exceeding 0.3 point (x) was judged as “bad”.

Based on the 4 ranks judgment criteria of the above-mentioned Examples 1 to 9, etc., “⋆” was added at the highest rank and “xx” was added at the lowest rank were added to evaluate with 6 ranks. Also, to differentiate from “⋆”, judgment criteria of “⊚” was set in detail. With regard to the overlapping portions (⊚, ◯, Δ, x) of the 4 ranks, there is no change to the judgment criteria of the above-mentioned Examples 1 to 9, etc.

An increased part (%) of the reflectance (%) is made a “point”. That is, for example, if the reflectance (%) of the surface of the structure before wiping with water is 0.2%, and the reflectance (%) of the surface of the structure after wiping with water is 0.3%, then, the increase of the reflectance (%) is “0.1 point”.

Incidentally, an increased value of the reflectance and the state at which the fingerprint stain was observed with eyes are roughly as follows.

### (Judgment Criteria)

[Increased Value of Reflectance and the State at which Fingerprint Stain was Observed with Eyes]
⋆: 0.1 point or less. Among the structures in which fingerprint stain cannot be observed from the front or from the oblique direction after five round trips, at the time of wiping with water of the three round trips, the stain cannot be observed from the front or from the oblique direction.
⊚: 0.1 point or less. Fingerprint stain cannot be observed from the front or from the oblique direction after five round trips. At the time of wiping with water of the three round trips, fingerprint stain can be observed from the front or the oblique direction.
∘: Larger than 0.1 point and 0.2 point or less. Fingerprint stain cannot be observed from the front but slightly observed from the oblique direction.
Δ: Larger than 0.2 point and 0.3 point or less. Fingerprint stain cannot be observed from the front but observed from the oblique direction.
x: Larger than 0.3 point and 0.5 point or less, fingerprint stain can be observed from the front.
xx: Larger than 0.5 point. Fingerprint stain can be observed from the front.

### <Contact Angle>

### <Storage Elastic Modulus>

### <180° C. Storage Elastic Modulus>

The measurement methods and definitions of the “contact angle”, the “storage elastic modulus” and the “180° C. storage elastic modulus” are the same as the measurement methods and definitions of the above-mentioned Examples 1 to 9, etc.

TABLE 4

| Structure Number | 1 | 2 | 3 | 4 | 5 | 6 | 7 | 8 | 9 | 10 | 11 | 12 |
|---|---|---|---|---|---|---|---|---|---|---|---|---|
| In Polyethylene glycol diacrylate represented | 70 | 53 | 61 | 61 | 61 | 61 | 61 | 61 | 61 | 70 | 53 | 61 |
| by the formula (2), m = 14 | | | | | | | | | | | | |
| Urethane (meth)acrylate (a) | 30 | 47 | 36 | 36 | 36 | 36 | 36 | 36 | 36 | 30 | 47 | 36 |
| Urethane (meth)acrylate (b) | | | 3 | 3 | 3 | 3 | 3 | 3 | 3 | | | 3 |
| Photopolymerization initiator | 5 | 5 | 5 | 5 | 5 | 5 | 5 | 5 | 5 | 5 | 5 | 5 |
| 1-hydroxycyclohexyl phenyl ketone | | | | | | | | | | | | |
| Fluorine series surfactant (a) | 0.5 | 0.5 | 0.5 | | | 3.0 | | | | | | |
| In formula (F), p = 8, q = 10, | | | | | | | | | | | | |
| R₁ = F, R₂ = H, R₃ = H and X = —CH₂CH₂O— | | | | | | | | | | | | |
| Fluorine series surfactant (b) | | | | 0.5 | | | | | | | | |
| In formula (F), p = 6, q = 5, | | | | | | | | | | | | |
| R₁ = F, R₂ = H, R₃ = H and X = —CH₂CH₂O— | | | | | | | | | | | | |
| Fluorine series surfactant (c) | | | | | 0.5 | | | | | | | |
| In formula (F), p = 6, q = 10, | | | | | | | | | | | | |
| R₁ = F, R₂ = H, R₃= H and X = —CH₂CH₂O— | | | | | | | | | | | | |
| Fluorine series surfactant (d) | | | | | | | 0.5 | | | | | |
| FL-100-100st (available from Shin-Etsu | | | | | | | | | | | | |
| Chemical Co., Ltd.) | | | | | | | | | | | | |
| Silicon series lubricant A | | | | | | | | 0.5 | | | | |
| X-22-164AS (available from Shin-Etsu | | | | | | | | | | | | |
| Chemical Co., Ltd.) | | | | | | | | | | | | |
| Silicon series lubricant B | | | | | | | | | 0.5 | | | |
| X-24-8201 (available from Shin-Etsu | | | | | | | | | | | | |
| Chemical Co., Ltd.) | | | | | | | | | | | | |
| Surface scratch resistance | 6 | 6 | 6 | 6 | 6 | 6 | 6 | 5 | 5 | 5 | 5 | 5 |
| Reflectance (%) before wiping with water | 0.2 | 0.2 | 0.2 | 0.2 | 0.2 | 0.2 | 0.2 | 0.2 | 0.2 | 0.2 | 0.2 | 0.2 |
| Contamination resistance | 0.2 | 0.2 | 0.2 | 0.2 | 0.2 | 0.2 | 0.5 | 0.8 | 0.7 | 0.2 | 0.4 | 0.2 |
| Reflectance (%) after wiping with water | | | | | | | | | | | | |
| Judgment | ⋆ | ⋆ | ⋆ | ⋆ | ⋆ | ⋆ | Δ | XX | X | ⊚ | ◯ | ⊚ |
| Contact angle (deg) | <10 | 12 | 10 | 10 | 10 | 10 | 35 | 60 | 45 | 10 | 35 | 18 |
| Storage elastic modulus [GPa] 25° C. | 0.48 | 1.12 | 0.75 | 0.78 | 0.74 | 0.79 | 0.79 | 0.79 | 0.79 | 0.48 | 1.13 | 0.76 |
| 180° C. Storage elastic modulus [GPa] | 0.25 | 0.45 | 0.32 | 0.34 | 0.33 | 0.35 | 0.35 | 0.35 | 0.35 | 0.24 | 0.48 | 0.30 |

The structures Nos. 1 to 7 containing the fluorine series surfactant were observed to be improved in surface scratch resistance as compared with the structures Nos. 8 to 12 that did not contain the fluorine series surfactant.

The structures Nos. 1 to 6 containing, in particular, the “fluorine series surfactant having an alkylene oxide recurring structure and a fluoroalkyl group” among the fluorine series surfactants were observed to be further improved particularly in both of surface scratch resistance and contamination resistance as compared with the structures Nos. 7 to 12 that did not contain the same.

The fluorine series surfactants (a), (b) and (c) formulated in the structures Nos. 1 to 6 are each a perfluoroalkylethylene oxide adduct.

On the other hand, in the structures Nos. 6 and 7 containing the silicon series lubricant A and the silicon series lubricant B, respectively, contamination resistance was each insufficient.

In both of the structure No. 1 where the content of the fluorine series surfactant was made 0.5 parts by mass based on 100 parts by mass of the (meth)acrylate compound, and the structure No. 6 where it was made 3.0 parts by mass, both of surface scratch resistance and contamination resistance were each similarly extremely good.

The structures produced in the examples shown in the above-mentioned Table 4 were all good and excellent in the antireflection performance of the light and the improved performance of light permeability.

### UTILIZABILITY IN INDUSTRY

The structure of the present invention is excellent in the antireflection performance of the light and the improved performance of light permeability, etc., so that good visibility can be provided. Also, it is excellent in mechanical strength (surface scratch resistance or surface abrasion resistance), contamination resistance, etc., so that it can be suitably utilized in the field which requires both of visibility and surface performances (scratch, stain, durability, etc.) including FPD such as LCD, PDP, OLED, FED, etc.; CRT; lens; aperture plate; show window; a cover for a meter, a headlight, a frame or an exhibition case, etc. In particular, it can be suitably utilized for the uses in which a mechanical external force is likely applied to the surface. In addition, more generally, it can be widely and suitably utilized for the purpose of antireflection, improvement in permeability, surface protection, etc.

The present application is based on Japanese Patent Application No. 2011-110889 which is a Japanese Patent Application filed on May 17, 2011, and all the contents of these applications are cited herein and incorporated as a disclosure of the specification of the present invention.

### EXPLANATION OF REFERENCE NUMERALS

1 Polymerizable composition
2 Mold
3 Substrate
4 Roller
5 Structure
6 Curing device
7 Supporting roller

1. A structure having convex parts with an average height of 100 nm or more and 1000 nm or less, or concave parts with an average depth of 100 nm or more and 1000 nm or less on a surface thereof, wherein the convex parts or the concave parts thereof are present at an average cycle of 50 nm or more and 400 nm or less in at least one direction, the structure is obtained by polymerizing a polymerizable composition containing a (meth)acrylate compound by light irradiation, electron beam irradiation and/or heating, the (meth)acrylate compound contains 53% by mass or more polyethylene glycol di(meth)acrylate based on the whole (meth)acrylate compound, and the structure has a storage elastic modulus at 25° C. of 2 GPa or less and/or a storage elastic modulus at 180° C. of less than 0.5 GPa.

2. The structure according to claim 1, wherein the polyethylene glycol di(meth)acrylate is represented by the following formula (1): 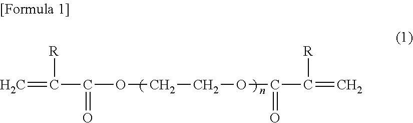
in the formula (1), R represents a hydrogen atom or a methyl group, n represents a number of recurring units, and a number of 4 or more to 40 or less in an average value.

3. The structure according to claim 1, wherein the (meth)acrylate compound further contains an urethane (meth)acrylate.

4. The structure according to claim 3, wherein the urethane (meth)acrylate contains tetra-functional or more of an urethane (meth)acrylate, and the tetra-functional or more of the urethane (meth)acrylate contains a material obtained by reacting a hydroxyl group of a compound having one hydroxyl group and two or more (meth)acryl groups in the molecule with substantially all the isocyanate groups of a polyvalent isocyanate compound.

5. The structure according to claim 1, wherein the polymerizable composition further contains a fluorine series surfactant having an alkylene oxide recurring structure and a fluoroalkyl group.

6. The structure according to claim 5, wherein the fluoroalkyl group has a carbon number of 2 or more and 18 or less.

7. The structure according to claim 5, wherein the fluoroalkyl group is a perfluoroalkyl group.

8. The structure according to claim 5, wherein a number of a recurring unit of the alkylene oxide recurring structure is 4 or more and 20 or less.

9. The structure according to claim 5, wherein the fluorine series surfactant having the alkylene oxide recurring structure and the fluoroalkyl group is represented by the following formula (F): 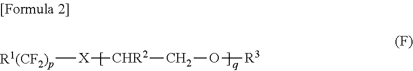
in the formula (F), R¹ represents H or F, R² represents H or CH₃, R³ represents H or CH₃, X represents a divalent linking group, p is an integer of 2 or more and 18 or less, and q is an integer of 4 or more and 20 or less.

10. The structure according to claim 1, wherein the structure has a surface in which a contact angle of water at 20° C. is 35° or less.

11. The structure according to claim 1, which is for antireflection of light and/or improvement of transmission of light.

12. A method for producing the structure according to claim 1, which comprises supplying a polymerizable composition to a mold having concave parts with an average height of 100 nm or more and 1000 nm or less or convex parts an average depth of 100 nm or more and 1000 nm or less at a surface thereof, wherein the convex parts or the concave parts thereof are present at an average cycle of 50 nm or more and 400 nm or less in at least one direction, contact bonding a substrate from thereon, curing the polymerizable composition, and peeling the structure from the mold.

13. The method for producing the structure according to claim 12, wherein the polymerizable composition further contains a fluorine series surfactant having an alkylene oxide recurring structure and a fluoroalkyl group.

14. A polymerizable composition for forming the structure according to claim 1, which comprises a (meth)acrylate compound, and the (meth)acrylate compound contains 53% by mass or more of a polyethylene glycol di(meth)acrylate based on the whole (meth)acrylate compound.

15. The polymerizable composition according to claim 14, wherein the polymerizable composition further contains a fluorine series surfactant having an alkylene oxide recurring structure and a fluoroalkyl group.

16. A material for forming an antireflection member which comprises the polymerizable composition for forming the structure according to claim 1, wherein the polymerizable composition contains a (meth)acrylate compound, and the (meth)acrylate compound contains 53% by mass or more of a polyethylene glycol di(meth)acrylate based on the whole (meth)acrylate compound.

17. The material for forming an antireflection member according to claim 16, wherein the polymerizable composition further contains a fluorine series surfactant having an alkylene oxide recurring structure and a fluoroalkyl group.
